(19) United States
(12) Patent Application Publication
(10) Pub. No.: US 2024/0371018 A1
(43) Pub. Date: Nov. 7, 2024

(54) USER TRACKING IN CONVERSATIONAL AI SYSTEMS AND APPLICATIONS

(71) Applicant: NVIDIA Corporation, Santa Clara, CA (US)

(72) Inventors: Pascal Joël Bérard, Zurich (CH); Christian Schüller, Frauenfeld (CH); Riccardo Elia Roveri, Zürich (CH)

(21) Appl. No.: 18/309,886

(22) Filed: May 1, 2023

(51) Int. Cl. G06T 7/55; G06T 7/246; G06T 7/73; G06V 40/16

(52) U.S. Cl. CPC G06T 7/55; G06T 7/248; G06T 7/74; G06V 40/161; G06T 2207/20081; G06T 2207/30201; G06V 40/20

(57) ABSTRACT

In various examples, user tracking for conversational AI systems and applications is described herein. Systems and methods are disclosed that use multiple detectors to detect and/or track users. For example, a head detector, a body detector, and/or a face detector may be used to detect users within images and/or track the users between the images. The systems and methods may further use one or more techniques to determine location information associated with the users. For examples, two-dimensional (2D) locations associated with the users within images may be used to determine three-dimensional (3D) locations associated with the users within an environment. The 3D locations may then be used to identify a primary user (e.g., a user that is currently interacting with a device) and/or zones for which the users are located. The systems and/or methods may then use the tracks and/or the locations to provide content to the users.

### BACKGROUND

Detecting and tracking users that are located in front of a camera or other sensor type in an arbitrary environment is a challenging task. For instance, it may be difficult to detect and/or track a user when the user continuously enters and/or leaves a field-of-view (FOV) of the sensor over a period of time, the user changes orientations such that a focus of the user is away from the sensor, the user is wearing a mask and/or other accessory that covers at least a portion of a face of the user, other users enter and/or leave the FOV of the sensor over the period of time, and/or so forth. In some circumstances, if a system is not able to detect and/or track the user using the sensor, the device may not operate as intended. For example, if the system is configured to interact with users, such as using animated or digital avatars, the device may cause an animated or digital avatar to interact when the user is not focusing on the device, cause the animated avatar to not interact when the user is actually focusing on the device, and/or cause the avatar to interact with the wrong user.

Because of this, systems have been developed that attempt to improve the detection and/or tracking of users. For instance, these systems may include added sensors, such as added cameras and/or depth sensors, to help in detecting and/or tracking users. However, adding sensors to the systems increases the amount of hardware and/or computing resources required by the systems when performing user detection and/or tracking. These systems may further include a single detector, such as a body detector, a head detector, or a face detector, for detecting and/or tracking users. However, if a detector used by a system fails, such as when the system is using a face detector and the face of the user is located outside of the FOV of the sensor, the system may again be unable to detect and/or track users. As such, these systems may still not operate as intended, such as when interacting with users.

### SUMMARY

Embodiments of the present disclosure relate to user trackers for conversational artificial intelligence (AI) systems and applications. Systems and methods are disclosed that use multiple detectors to detect and/or track users. For example, a head detector, a body detector, and/or a face detector may be used to detect users within images (and/or other sensor data representations, such as point clouds, range images, etc.) and/or track the users between the images (and/or other sensor data representations). The systems and methods may further use one or more techniques to determine location information associated with the users. For example, two-dimensional (2D) locations associated with the users within images may be used to determine three-dimensional (3D) locations associated with the users within an environment. The 3D locations may then be used to identify a primary user (e.g., a user that is currently interacting with a device) and/or zones for which the users are located. Additionally, the systems and methods may use the detections, the tracking, and/or the location information to provide content to the users.

In contrast to conventional systems, such as those described above, the current systems use multiple detectors to both detect and track users, which may improve the overall detection and/or tracking capabilities of the current systems. For example, as mentioned above, conventional systems may use a single detector, such as a face detector, to attempt to detect and track users. However, if this single point of failure materializes, such as when a face of a user is no longer located within a field-of-view (FOV) of a camera, the detection and/or tracking of the conventional systems may also fail. In contrast, by using multiple types of detectors, the systems may benefit from multi-point failure such that even if one of the detectors fails, such as the face detector failing based on the face of the user again no longer being within the FOV of the camera, the current systems may still be able to detect and/or track the user using other detectors, such as the body detector.

Additionally, in contrast to the conventional systems, the current systems, in some embodiments, are able to perform user detection and/or tracking using a single monocular camera. For instance, and as described in more detail herein, the current systems use one or more processes to determine both two-dimensional (2D) locations and three-dimensional (3D) locations of users using image data generated using the monocular camera. The current systems are then able to use the 2D locations and/or the 3D locations to determine zones for this the users are located, determine which user is the primary user, and/or determine additional information associated with the users. In some circumstances, this information is then used by the current systems when providing content, such as interacting with the users.

### BRIEF DESCRIPTION OF THE DRAWINGS

The present systems and methods for user tracking in conversational AI systems and applications are described in detail below with reference to the attached drawing figures, wherein:

FIG. 1 illustrates an example data flow diagram for a process of detecting, tracking, and interacting with users, in accordance with some embodiments of the present disclosure;

FIGS. 2A-2B illustrate an example of detecting users depicted in an image, in accordance with some embodiments of the present disclosure;

FIG. 3 illustrates an example of predicting locations of detections in a new image, in accordance with some embodiments of the present disclosure

FIG. 4A-4B illustrate examples of tracking users between images, in accordance with some examples of the present disclosure;

FIGS. 5A-5C illustrate examples of associating users with zones corresponding to a device, in accordance with some embodiments of the present disclosure;

FIG. 6 illustrates an example of selecting a user when two users are located proximate to one another, in accordance with some embodiments of the present disclosure;

FIG. 7 illustrates an example of selecting a primary user, in accordance with some embodiments of the present disclosure;

FIGS. 8A-8B illustrate examples of determining an attentiveness of a user, in accordance with some embodiments of the present disclosure;

FIG. 9 is a flow diagram showing a method for tracking a user between images, in accordance with some embodiments of the present disclosure;

FIG. 10 is a flow diagram showing a method for merging detections associated with a user, in accordance with some embodiments of the present disclosure;

FIG. 11 is a flow diagram showing a method for determining a primary user of a device, in accordance with some embodiments of the present disclosure;

FIG. 12 is a flow diagram showing a method for determining an attentiveness of a user with respect to a display, in accordance with some embodiments of the present disclosure;

FIG. 13 is a block diagram of an example computing device suitable for use in implementing some embodiments of the present disclosure; and

FIG. 14 is a block diagram of an example data center suitable for use in implementing some embodiments of the present disclosure.

### DETAILED DESCRIPTION

Systems and methods are disclosed related to user tracking in conversational AI systems and applications. For instance, a system(s) may receive image data generated using one or more image sensors (e.g., one or more cameras) associated with a device. In some examples, the device may include a monocular camera while, in other examples, the device may include any number of image sensors and/or any type of camera. The system(s) may then process the image data using one or more detectors to detect one or more users depicted in a first image represented by the image data. As described herein, the detectors may include, but are not limited to, a body detector that is trained to determine key points associated with bodies (e.g., skeletons) of users, a head detector that is trained to determine bounding shapes (e.g., bounding boxes) associated with heads of the users, a face detector that is trained to determine bounding shapes (e.g., bounding boxes) associated with faces of the users, and/or any other type of detector (e.g., an eye detector, a nose detector, an ear detector, etc.). The system(s) may then match the skeleton(s) associated with one or more bodies depicted in the first image, the bounding shape(s) for one or more heads depicted in the first image, and/or the bounding shape(s) for one or more faces depicted in the first image with the user(s) depicted in the first image. Additionally, the system(s) may generate data (e.g., tracked data) representing information associated with the detected user(s), such as by associating the user(s) with the skeleton(s), the bounding shape(s) for the head(s), and/or the bounding shape(s) for the face(s).

The system(s) may then track one or more of the user(s) from the first image to a second, subsequent image represented by the image data. For example, the system(s) may perform one or more techniques (e.g., use one or more tracking algorithms) to determine a predicted location(s) of a bounding shape(s) associated with the skeleton(s), a predicted location(s) of the bounding shape(s) associated with the head(s), and/or a predicted location(s) of the bounding shape(s) associated with the face(s) in the second image based on the locations of these detections in at least the first image (and/or additional previous images)). The system(s) may further use the detectors above to determine a location(s) of a skeleton(s) within the second image, a location(s) of a bounding shape(s) associated with a head(s) in the second image, and/or a location(s) of a bounding shape(s) associated with a face(s) in the second image. The system(s) may then use the predicted location(s) and the determined location(s) for the second image in order to track one or more of the user(s) from the first image to the second image.

The system(s) may then perform one or more processes based on the tracking. For a first example, if the system(s) is able to track a user from the first image to the second image, the system(s) may update the tracked data to represent information associated with the user in the second image. For a second example, if the system(s) is unable to track a user from the first image to the second image (e.g., the user is not depicted in the second image), the system(s) may update the tracked data to represent information indicating that the second image does not depict the user. Still, for a third example, if the system(s) detects a user in the second image that was not detected in the first image (e.g., a new user), the system(s) may update the tracked data to represent information associated with the new user. The system(s) may then continue to perform these processes to continue tracking users between images represented by the image data.

In some examples, the system(s) may determine location information associated with one or more of the users. For example, and for a user, the system(s) may determine a two-dimensional (2D) location of the skeleton in an image, a 2D location of a bounding shape associated with the head in the image, and/or a 2D location of a bounding shape associated with a face in the image. The system(s) may then use one or more of the 2D locations to determine a three-dimensional (3D) location associated with the user within an environment. For a first example, if the system(s) is only able to determine one of the 2D locations (e.g., only the body, the head, or the face of the user is depicted in the image), then the system(s) may use that 2D location to determine the 3D location associated with the user within the environment. For a second example, if the system(s) is able to determine multiple 2D locations associated with the user, then the system(s) may use those 2D locations to determine 3D locations associated with the user within the environment. The system(s) may then use the 3D locations to determine the final 3D location of the user (e.g., based on an average of the 3D locations) within the environment.

In some examples, the system(s) may determine zones for which one or more of the users are located. For example, such as when the image sensor(s) is associated with a device (e.g., a kiosk, a tablet, a computer, a display, etc.), the system(s) may associate the device with the zones. As described herein, the zones may include, but are not limited to, an active zone, a passive near zone, a passive far zone, an outer zone, and/or any other type of zone. As such, the active zone may include an area of the environment that is closest to the device, the passive near zone may include an area of the environment that is further from the device than the active zone, the passive far zone may include an area of the environment that is further from the device than the passive near zone, and the outer zone may include the rest of the environment. As such, the system(s) may use a location (e.g., a 2D location, a 3D location, etc.) associated with the user to determine which zone the user is currently located. For example, if the location of the user is within the active zone, then the system(s) may determine that the user is located within and/or associated with the active zone.

In some examples, the system(s) may perform one or more processes in order to identify a specific user(s) within the environment. For a first example, if two or more users are close in proximity (e.g., depicted as at least partially overlapping within an image), then the system(s) may select one of the users. In some examples, the system(s) may determine that the two users are close in proximity based on one or more of the bounding shapes (e.g., a bounding shape associated with the skeleton, a bounding shape associated with the head, a bounding shape associated with the face, etc.) associated with the first user overlapping with one or more of the bounding shapes (e.g., a bounding shape associated with the skeleton, a bounding shape associated with the head, a bounding shape associated with the face, etc.) associated with the second user (e.g., partially overlapping, overlapping by a threshold amount, etc.). In some examples, the system(s) may determine that the two users are close in proximity based on a final bounding shape associated with the first user overlapping with a final bounding shape associated with the second user. In such an example, the system(s) may determine a final bounding shape associated with a user using one or more of the bounding shapes associated with the skeleton, the bounding shape associated with the head, and/or the bounding shape associated with the face. In any of these examples, the system(s) may then select the user that is closest to the device.

For a second example, the system(s) may perform one or more processes to determine a primary user associated with the device. For instance, if the system(s) detects only one user, then the system(s) may determine that the user includes the primary user (e.g., as long as the user is within one or more specific zones). However, if the system(s) detects multiple users, then the system(s) may determine a distance(s) between one or more (e.g., each) of the users and the device and/or a distance(s) between one or more (e.g., each) of the users and a line that is projected perpendicular from a center of the device (e.g., a center of a display of the device). The system(s) may then use the distances to determine the primary user. For example, the system(s) may select the user that is closest to the device and/or closest to the center of the device.

In some examples, the system(s) may determine attributes associated with one or more of the users (e.g., a primary user, a user(s) located within a specific zone(s), all users, etc.). As described herein, an attribute for a user may include, but is not limited to, an age of the user, an attention of the user, whether the user is wearing a mask and/or other accessory on the face, an emotion of the user, a hair length of the user, a hair color of the user, a color(s) of one or more pieces of clothing of the user, a type(s) of one or more pieces of clothing of the user, and/or any other attribute associated with the user. In some examples, the system(s) may determine one or more of the attributes using one or more machine learning model(s) and/or one or more other techniques.

For instance, the system(s) may use one or more techniques to determine the attentiveness of the user. For a first example, if a user is located in front of the device (e.g., in front of a display of the device), then the system(s) may determine a first vector that is associated with an orientation of the user and a second vector that is perpendicular to a center of the display. The system(s) may then determine the attentiveness of the user using the vectors. For a second example, if a user is located to a side of the device (e.g., outside of the front of the display), then the system(s) may determine the first vector that is associated with the orientation of the user and a second vector that is from an edge of the device (e.g., an edge of the display) to the head of the user. The system(s) may then again determine the attentiveness of the user using the vectors. In some examples, the system(s) may determine either that the user is paying attention to the device (e.g., focusing on the device) or not paying attention to the display (e.g., not focusing on the device). In some examples, the system(s) may use a range of attentiveness, such that a first value is associated with the user completely paying attention to the device, a second value is associated with the user not paying any attention to the device, and values between the first value and the second value are associated with different levels of attentiveness.

In some examples, the system(s) may generate one or more events based on one or more of the determinations described herein. For a first example, the system(s) may output data based on a user being located within one or more zones (e.g., the active zone). For a second example, the system(s) may output data based on a user being located within the one or more zones and the user paying attention to the device (e.g., the attentiveness value being equal to or greater than a threshold value). Still, for a third example, the system(s) may output data based on a user paying attention to the device. In some examples, the output data may be associated with an avatar that interacts with the user, such as through conversation and/or motion. However, in other examples, the output data may include any other type of content that may be provided by the system(s).

In some examples, the system(s) may continue to perform one or more of the processes described herein. For example, the system(s) may continue to perform one or more of the processes described herein to detect users, track users, determine location information associated with users, select users, determine primary users, determine attentiveness associated with users, provide output to users, and/or the like. In some examples, while continuing to perform these processes, the system(s) may also continue to update the data (e.g., the tracking data) associated with the users. For example, the system(s) may continue to track the users interacting with the device, even if the users leave the FOV of the image sensor(s) and/or reenter the FOV of the image sensor(s). This way, the system(s) may be able to interact with users as the users are moving around the device and/or as new users begin to interact with the device.

The examples herein describe determining an amount of overlap between a first bounding shape and a second bounding shape. In some examples, the amount of overlap is determined using intersection over union (IoU). For a first example, if the second bounding shape overlaps with 50% of the first bounding shape, then the system(s) may determine that the amount of overlap is 50%. Additionally, if the second bounding shape overlaps with 100% of the first bounding shape, then the system(s) may determine that the amount of overlap is 100%. The examples herein then describe determining whether the amount of overlap satisfies a threshold amount of overlap. As described herein, the threshold amount of overlap may include, but is not limited to, 50%, 75%, 90%, 95%, and/or any other percentage of overlap. Additionally, the amount of overlap may satisfy the threshold amount of overlap when the amount of overlap is equal to or greater than the threshold amount of overlap and not satisfy the threshold amount of overlap when the amount of overlap is less than then threshold amount of overlap.

The systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, autonomous or semi-autonomous machine applications, deep learning, environment simulation, object or actor simulation and/or digital twinning, data center processing, conversational AI (such as using one or more language models, including one or more large language models (LLMs) that may process text, audio, and/or image data or other sensor data), light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems implementing one or more large language models (LLMs), systems for hosting or presenting one or more digital avatars, systems for performing light transport simulation, systems for performing collaborative content creation for 3D assets, systems implemented at least partially using cloud computing resources, and/or other types of systems.

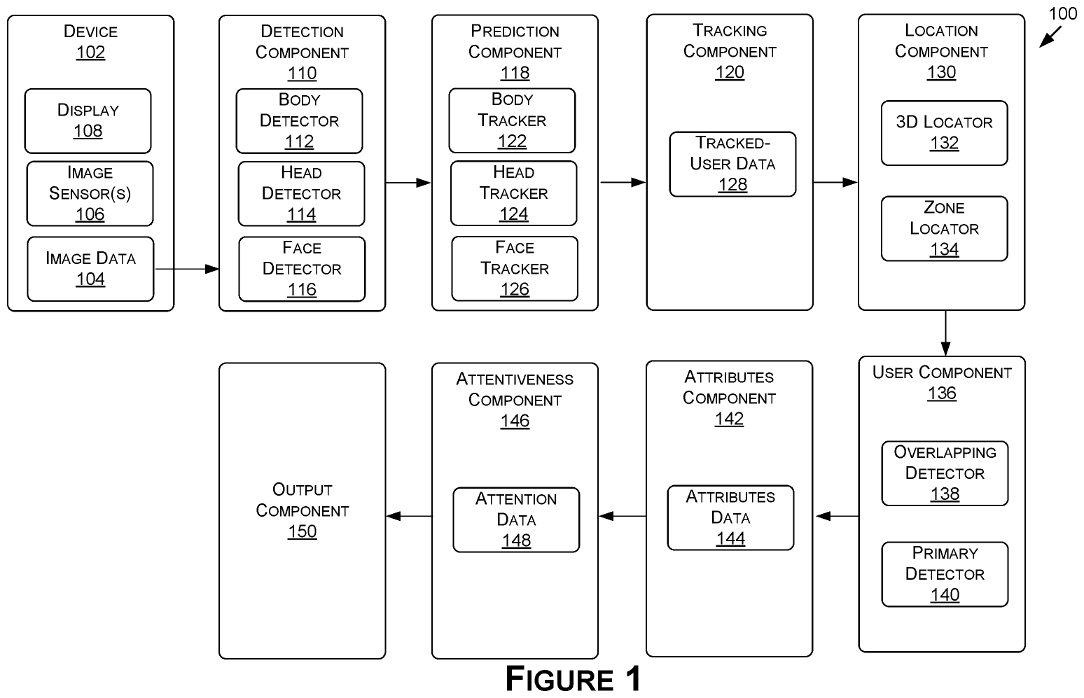

With reference to FIG. 1, FIG. 1 illustrates an example data flow diagram for a process 100 of detecting, tracking, and interacting with users, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

The process 100 may include a device 102 generating image data 104 using one or more image sensors 106. As described herein, the device 102 may include, but is not limited to, a kiosk, a tablet, a computer, a display, a mobile device, and/or any other type of device that includes a display 108 and/or provides content to users. In some examples, the image sensor(s) 106 may include a single monocular camera. However, in other examples, the device 102 may include any number of image sensors 106 and/or the image sensors 106 may include any type of camera. In some embodiments, sensor modalities other than cameras may additionally or alternatively be employed, such as RADAR sensors, LiDAR sensors, ultrasonic sensors, etc. In some examples, the device 102 may then preprocess the image data 104 before the image data 104 is processed by one or more components.

For instance, in some examples, the image data 104 may be captured in one format (e.g., RCCB, RCCC, RBGC, etc.), and then converted (e.g., during pre-processing of the image data 104) to another format. In some other examples, the image data 104 may be provided as input to an image data pre-processor (not shown) to generate pre-processed image data 104. Many types of images or formats may be used as inputs; for example, compressed images such as in Joint Photographic Experts Group (JPEG), Red Green Blue (RGB), or Luminance/Chrominance (YUV) formats, compressed images as frames stemming from a compressed video format such as H.264/Advanced Video Coding (AVC) or H.265/High Efficiency Video Coding (HEVC), raw images such as originating from Red Clear Blue (RCCB), Red Clear (RCCC) or other type of imaging sensor.

The image data pre-processor may use image data 104 representative of one or more images (or other data representations) and load the image data 104 into memory in the form of a multi-dimensional array/matrix (alternatively referred to as tensor, or more specifically an input tensor, in some examples). The array size may be computed and/or represented as W x H x C, where W stands for the image width in pixels, H stands for the height in pixels, and C stands for the number of color channels. Without loss of generality, other types and orderings of input image components are also possible. Additionally, the batch size B may be used as a dimension (e.g., an additional fourth dimension) when batching is used. Batching may be used for training and/or for inference. Thus, the input tensor may represent an array of dimension W x H x C x B. Any ordering of the dimensions may be possible, which may depend on the particular hardware and software used to implement the sensor data pre-processor. This ordering may be chosen to maximize training and/or inference performance of the machine learning model(s).

Where noise reduction is employed by the image data pre-processor, it may include bilateral denoising in the Bayer domain. Where demosaicing is employed by the image data pre-processor, it may include bilinear interpolation. Where histogram computing is employed by the image data pre-processor, it may involve computing a histogram for the C channel, and may be merged with the decompanding or noise reduction in some examples. Where adaptive global tone mapping is employed by the image data pre-processor, it may include performing an adaptive gamma-log transform. This may include calculating a histogram, getting a mid-tone level, and/or estimating a maximum luminance with the mid-tone level.

The process 100 may include a detection component 110 that is configured to process the image data 104 in order to detect users in images represented by the image data 104. As shown, the detection component 110 may process the image data 104 using any number of detectors, such as a body detector 112, a head detector 114, and/or a face detector 116. The body detector 112 may be trained to process the image data 104 and, based on the processing, output data representing the locations of key points and/or a skeleton that connects the key points for one or more (e.g., each) user depicted in images. In some examples, the input into the body detector 112 includes cropped images that depict the users while, in other examples, the input into the body detector 112 may include entire images. Additionally, the key points associated with a user may represent elbows, shoulders, hands, knees, feet, eyes, a nose, ears, hips, and/or any other point on the user.

The head detector 114 may be trained to process the image data 104 and, based on the processing, output data representing the locations of bounding shapes (e.g., a bounding boxes) associated with one or more (e.g., each) head depicted in the images. In some examples, the input into the head detector 114 may include cropped images that depict at least the heads while, in other examples, the input into the head detector 114 may include entire images. Additionally, the face detector 116 may be trained to process the image data 104 and, based on the processing, output data representing the locations of bounding shapes (e.g., bounding boxes) associated with one or more (e.g., each) face depicted in the images. In some examples, the input into the face detector 116 may include cropped images that depict at least the faces while, in other examples, the input into the face detector 114 may include entire images.

The detection component 110 may then be configured to match the detections (e.g., the key points and/or skeletons, the head bounding shapes, the face bounding shapes, etc.) to the users depicted in the images. For instance, the detection component 110 may initially perform one or more preprocesses with the detections before the detections are merged. In some examples, the detection component 110 may initially remove detections that are too small (e.g., less than a threshold size). For examples, if a bounding shape associated with a face detection is too small, such that the user is located a large distance from the image sensor(s) 106, then the detection component 110 may remove the detection. In some examples, the detection component 110 may combine two detections that are the same and at least partially overlap. For example, if the detection component 110 determines that two face bounding shapes overlap (e.g., IoU) by at least a threshold amount of overlap, then the detection component 110 combines the two bounding shapes and/or select one of the bounding shapes.

The detection component 110 may then merge (e.g., associate) the detections. For instance, the detection component 110 may use overlaps between head bounding shapes and face bounding shapes to merge the head bounding shapes with the face bounding shapes. For example, the detection component 110 may determine an amount of overlap (e.g., using IoU) between a head bounding shape and a face bounding shape. If the amount of overlap satisfies (e.g., is equal to or greater than) a threshold amount of overlap, then the detection component 110 may merge (e.g., associate) the head bounding shape with the face bounding shape. However, if the amount of overlap does not satisfy (e.g., is less than) the threshold amount of overlap, then the detection component 110 may not merge the head bounding shape with the face bounding shape. In some examples, the detection component 110 may perform similar processes for one or more (e.g., each) of the head bounding shapes and the face bounding shapes. Additionally, in some examples, the detection component 110 may determine that one or more head detections do not merge with a face detection, such as when a user is facing away from the image sensor(s) 106.

For example, if a user is oriented such that the user is facing away from the image sensor(s) 106, then the image of the user may depict the head of the user without depicting the face of the user. In such an example, the head detector 114 may generate a head bounding shape, but the face detector 116 may not generate a face bounding shape. As such, the detection component 110 may determine that there is no face detection associated with the head detection.

The detection component 110 may also use overlaps to merge body detections with head detections and/or face detections. For example, for a body detection, the detection component 110 may use key points associated with the face (e.g., the ears, nose, mouth, chin, etc.) to generate a bounding shape associated with the body detection. The detection component 110 may then determine an amount of overlap (e.g., using IoU) between the generated bounding shape and a head bounding shape and/or a face bounding shape. If the amount of overlap satisfies (e.g., is equal to or greater than) a threshold amount of overlap, then the detection component 110 may merge (e.g., associate) the body detection with the head bounding shape and/or the face bounding shape. However, if the amount of overlap does not satisfy (e.g., is less than) the threshold amount of overlap, then the detection component 110 may not merge the body detection with the head bounding shape and/or the face bounding shape. In some examples, the detection component 110 may perform similar processes for one or more (e.g., each) of the body detections. Additionally, in some examples, the detection component 110 may determine that one or more body detections do not merge with a head detection and/or a face detection (e.g., the image only depicts the body of the user).

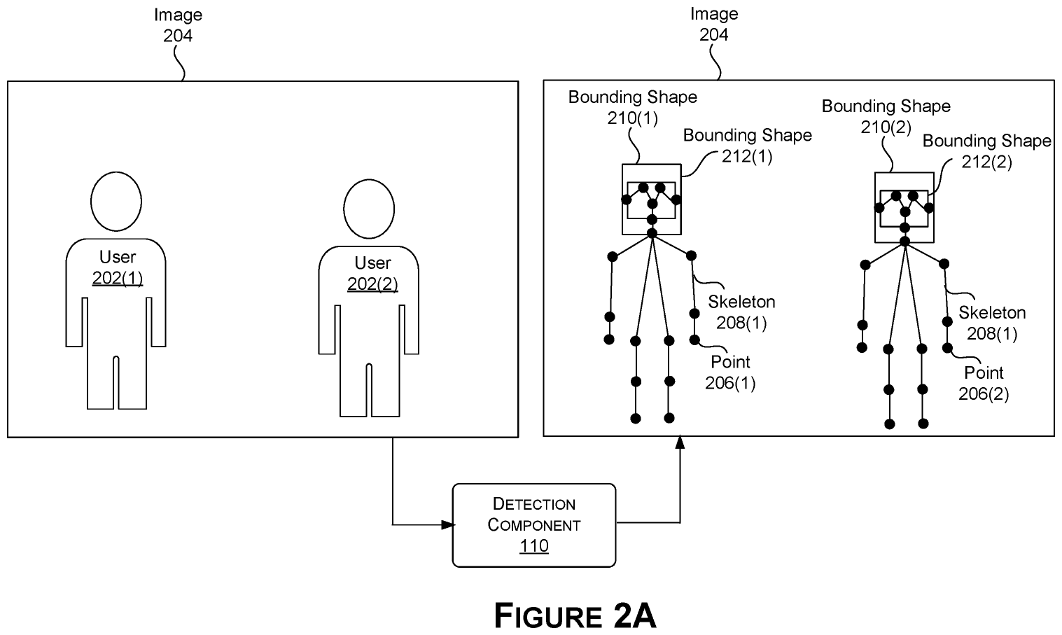

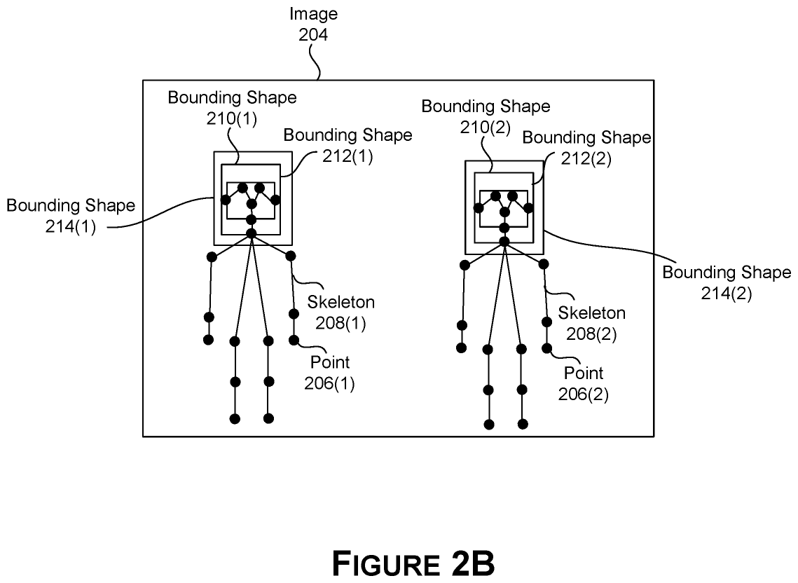

For instance, FIGS. 2A-2B illustrate an example of detecting users 202(1)-(2) depicted in an image 204, in accordance with some embodiments of the present disclosure. As shown by the example of FIG. 2A, the detection component 110 may process image data representative of the image 204, where the image 204 depicts the two users 202(1)-(2). Based on the processing, the body detector 112 may generate data indicating locations of key points 206(1) (although only one is labeled for clarity reasons) associated with a body depicted in the image 204, a location of a skeleton 208(1) associated with the key points 206(1), locations of key points 206(2) (although only one is again labeled for clarity reasons) associated with a body depicted in the image 204, and/or a location of a skeleton 208(2) associated with the key points 206(2). Additionally, the head detector 114 may generate data indicating locations of bounding shapes 210(1)-(2) associated with heads depicted in the image 204. Furthermore, the face detector 116 may generate data indicating the locations of bounding shapes 212(1)-(2) associated with faces depicted in the image 204.

As shown by the example of FIG. 2B, the detection component 110 may then merge the body detections (e.g., the key points 206(1)-(2) and/or the skeletons 208(1)-(2)), the head detections (e.g., the bounding shapes 210(1)-(2)), and the face detections (e.g., the bounding shapes 212(1)-(2)). For a first example, the detection component 110 may determine a first amount of overlap between the head bounding shape 210(1) and the face bounding shape 212(1) and/or a second amount of overlap between the head bounding shape 210(1) and the face bounding shape 212(2). The detection component 110 may then determine to merge the head bounding shape 210(1) with the face bounding shape 212(1) based on the amounts of overlap. In some examples, the detection component 110 performs the merging based on the first amount of overlap satisfying a threshold amount of overlap and/or the second amount of overlap not satisfying the threshold amount of overlap. In some examples, the detection component 110 performs the merging based on the first amount of overlap being greater than the second amount of overlap.

For a second example, the detection component 110 may determine a first amount of overlap between the head bounding shape 210(2) and the face bounding shape 212(1) and/or a second amount of overlap between the head bounding shape 210(2) and the face bounding shape 212(2). The detection component 110 may then determine to merge the head bounding shape 210(2) with the face bounding shape 212(2) based on the amounts of overlap. In some examples, the detection component 110 performs the merging based on the first amount of overlap not satisfying a threshold amount of overlap and/or the second amount of overlap satisfying the threshold of overlap. In some examples, the detection component 110 performs the merging based on the second amount of overlap being greater than the first amount of overlap.

For a third example, the detection component 110 may generate a bounding shape 214(1) using one or more of the key points 206(1) (e.g., the key points 206(1) associated with the face). The detection component 110 may then determine a first amount of overlap between the bounding shape 214(1) and the head bounding shape 210(1) and/or the face bounding shape 212(1) and/or a second amount of overlap between the bounding shape 214(1) and the head bounding shape 210(2) and/or the face bounding shape 212(2). The detection component 110 may then determine to merge the body detection associated with the key points 206(1) and/or the skeleton 208(1) with the head bounding shape 210(1) and/or the face bounding shape 212(1) based on the amounts of overlap. In some examples, the detection component 110 performs the merging based on the first amount of overlap satisfying a threshold amount of overlap and/or the second amount of overlap not satisfying the threshold amount of overlap. In some examples, the detection component 110 performs the merging based on the first amount of overlap being greater than the second amount of overlap.

Still, for a fourth example, the detection component 110 may generate a bounding shape 214(2) using one or more of the key points 206(2) (e.g., the key points 206(2) associated with the face). The detection component 110 may then determine a first amount of overlap between the bounding shape 214(2) and the head bounding shape 210(1) and/or the face bounding shape 212(1) and/or a second amount of overlap between the bounding shape 214(2) and the head bounding shape 210(2) and/or the face bounding shape 212(2). The detection component 110 may then determine to merge the body detection associated with the key points 206(2) and/or the skeleton 208(2) with the head bounding shape 210(2) and/or the face bounding shape 212(2) based on the amounts of overlap. In some examples, the detection component 110 performs the merging based on the first amount of overlap not satisfying a threshold amount of overlap and/or the second amount of overlap satisfying the threshold amount of overlap. In some examples, the detection component 110 performs the merging based on the second amount of overlap being greater than the first amount of overlap.

In some examples, the detection component 110 may then perform one or more additional processes based on the merging. For a first example, the detection component 110 may generate data (e.g., tracking data) that associates first detections (e.g., key points 206(1), the skeleton 208(1), the head bounding shape 210(1), and the face bounding shape 212(1)) with a first identifier associated with the user 202(1) and second detections (e.g., the key points 206(2), the skeleton 208(2), the head bounding shape 210(2), and the face bounding shape 212(2)) with a second identifier associated with the user 202(2). For a second example, the detection component 110 may generate a final bounding shape associated with the user 202(1) using the first detections and/or a final bounding shape associated with the user 202(2) using the second detections.

Referring back to the example of FIG. 1, the process 100 may include a prediction component 118 and a tracking component 120 that are configured to track users depicted in the images. For instance, the prediction component 118 may initially be configured to predict where users are moving between images. To perform the prediction, the prediction component 118 may include a body tracker 122 that is configured to predict where the bodies of the users will be in a new image using the locations of the bodies in one or more previous images. In some examples, to make the prediction, the body tracker 122 may generate bounding shapes associated with the bodies (e.g., using the key points, the skeletons, etc.) within the previous image(s) and then use the locations of the bounding shapes to predict the locations of the bounding shapes in the new image. For example, if the body bounding shapes of a user in previous images indicate that the user is walking in a specific direction, then the body tracker 122 may predict that the body in the new image will be further in that direction.

The prediction component 118 may also include a head tracker 124 that is configured to predict where the heads of the users will be in a new image using the locations of the heads one or more previous images. For a first example, if the head bounding shapes of a head in previous images indicate that the head is moving in a specific direction, then the head tracker 124 may predict that the head in the new image will be further in the specific direction. For a second example, if the head bounding shapes for a head in previous images indicate that the head is stationary, then the head tracker 124 may predict that the head in the new image will be at the same location. Furthermore, the prediction component 118 may include a face tracker 126 that is configured to predict where the faces of the users will be in a new image using the locations of the faces one or more previous images. For a first example, if the face bounding shapes of a face in previous images indicate that the face is moving in a specific direction, then the face tracker 126 may predict that the face in the new image will be further in the specific direction. For a second example, if the face bounding shapes for a face in previous frames indicate that the face is stationary, then the face tracker 126 may predict that the face in the new image will be at the same location.

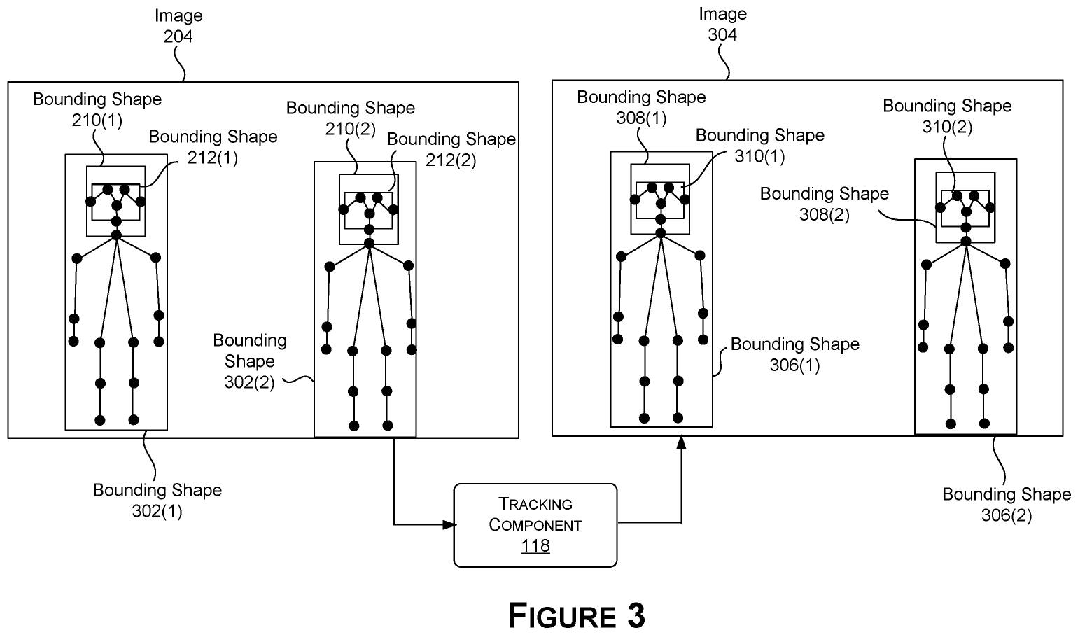

For instance, FIG. 3 illustrates an example of predicting the locations of detections in a new image, in accordance with some embodiments of the present disclosure. As shown, the prediction component 118 may use the key points 206(1) and/or the skeleton 208(1) to generate a bounding shape 302(1) associated with the user 202(1) and the key points 206(2) and/or the skeleton 208(2) to generate a bounding shape 302(2) associated with the user 202(2). The prediction component 118 may then use the body tracker 122 to predict the location of the bounding shape 302(1) in a new image 304, which is indicated by bounding shape 306(1), and predict the location of the bounding shape 302(2) in the image 304, which is indicated by bounding shape 306(2). The prediction component 118 may also use the head tracker 124 to predict the location of the bounding shape 210(1) in the image 304, which is indicated by bounding shape 308(1), and predict the location of the bounding shape 210(2) in the image 304, which is indicated by bounding shape 308(2). The prediction component 118 may then use the face tracker 126 to predict the location of the bounding shape 212(1) in the image 304, which is indicated by the bounding shape 310(1), and predict the location of the bounding shape 212(2) in the image 304, which is indicated by bounding shape 310(2).

Referring back to the example of FIG. 1, the tracking component 120 may then be configured to create, update, and/or terminate tracks associated with users across images. For instance, and for a new image, the tracking component 120 may use the detections from the detection component 110 and the predictions from the prediction component 118 to track the users across images. For example, the tracking component 120 may determine amounts of overlap between the predicted bounding shapes for tracked users and the detected bounding shapes for users. In some examples, the tracking component 120 determines first amounts of overlap between predicted body bounding shapes and detected body bounding shapes, second amounts of overlap between predicted head bounding shapes and detected head bounding shapes, and/or third amounts of overlap between predicted face bounding shapes and detected face bounding shapes. Additionally, or alternatively in some examples, the tracking component 120 determines final predicted bounding shapes for the tracked users and final detected bounding shapes for the detected users and then determines amounts of overlap between the final predicted bounding shapes and the final detected bounding shapes. In such examples, the tracking component 120 may determine a final bounding shape using the body bounding shape, the head bounding shape, and/or the face bounding shape associated with a user (e.g., predicted or detected).

The tracking component 120 may then use the amounts of overlap to track users between the images. For a first example, such as when the tracking component 120 determines amounts of overlap for different types of detections, the tracking component 120 may track a user from a previous image(s) to the new image based on at least one of the amounts of overlap satisfying (e.g., being equal to or greater than) a threshold amount of overlap. For instance, if a first amount of overlap between a predicted body bounding shape and a determined body bounding shape, a second amount of overlap between a predicted head bounding shape and a determined head bounding shape, and/or a third amount of overlap between a predicted face bounding shape and a determined face bounding shape satisfies the threshold amount of overlap, then the tracking component 120 may track the user associated with the predicted bounding shapes in the new image. However, in other examples, the tracking component 120 may track the user based on amounts of overlap for two or more of the bounding shapes satisfying the threshold amount of overlap and/or a specific bounding shape (e.g., the body bounding shape, the head bounding shape, or the face bounding shape) satisfying the threshold amount of overlap.

For a second example, such as when the tracking component 120 determines amounts of overlap between final predicted bounding shapes and final detected bounding shapes, the tracking component 120 may track a user from a previous image(s) to the new image based on an amount of overlap satisfying (e.g., being equal to or greater than) a threshold amount of overlap. For instance, if an amount of overlap between a predicted final bounding shape for a tracked user and a detected final bounding shape for a detected user in the new image satisfies the threshold amount of overlap, then the tracking component 120 may determine that the detected user is the tracked user.

In some examples, the tracking component 120 may use one or more additional and/or alternative techniques to track the users. For instance, the tracking component 120 may use data representing information associated with the tracked users, such as facial detection information, clothes information (e.g., colors, types, accessories, etc.), attribute information (e.g., age, etc.), and/or the like to track the users from the previous image(s) to the new image. For a first example, the tracking component 120 may use the facial detection information to perform facial detection on the users depicted in the new image in order to match a tracked user to one of the users. For a second example, the tracking component 120 may use the clothing information to match the clothes being worn by a tracked user with the clothes being worn by a detected user in the new image to match the tracked user with the detected user. In some examples, the tracking component 120 may perform such processes when the tracking performed using the bounding shapes fails. In some examples, the tracking component 120 may perform such processes in addition to the tracking that is performed using the bounding shapes.

In some examples, the tracking component 120 may also detect a new user(s) within the new image. For example, if the tracking component 120 is unable to associate one of the tracked users with a newly detected user in the new image, then the tracking component 120 may determine that the detected user is a new user. Additionally, in some examples, the tracking component 120 may remove a tracked user(s). For example, if the tracking component 120 is unable to associate a tracked user with one of the detected users, then the tracking component 120 may determine that the tracked user is not depicted in the new image. As such, the tracking component may determine to remove the tracked user.

The tracking component 120 may also generate and/or update tracked-user data 128 associated with the tracked users. For example, the tracked-user data 128 may represent identifiers associated with the tracked users (which is described in more detail herein), attributes associated with the tracked users, locations of the tracked users (which is described in more detail herein), which tracked user is a primary user (which is also described in more detail herein), and/or any other information associated with tracked users. In some examples, the tracking component 120 updates the tracked-user data 128 (e.g., the information associated with the tracked users) with each image, at given time instances (e.g., every second, five seconds, ten seconds, etc.), and/or at one or more additional instances. In some examples, the tracking component 120 updates the tracked-user data 128 to remove track users based on the occurrences of one or more events. For example, if the tracking component 120 is unable to detect a tracked user in a specific number of consecutive frames (e.g., one frame, five frames, ten frames, fifty frames, etc.) and/or for a threshold period of time (e.g., one minute, five minutes, ten minutes, twenty minutes, etc.), the tracking component 120 may terminate the track associated with the user.

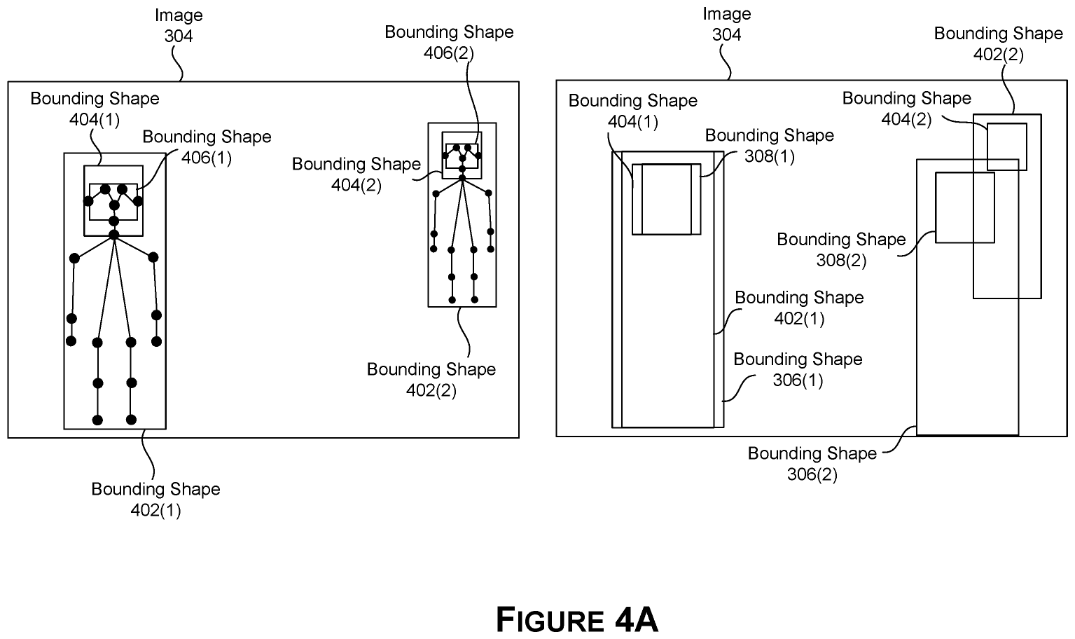

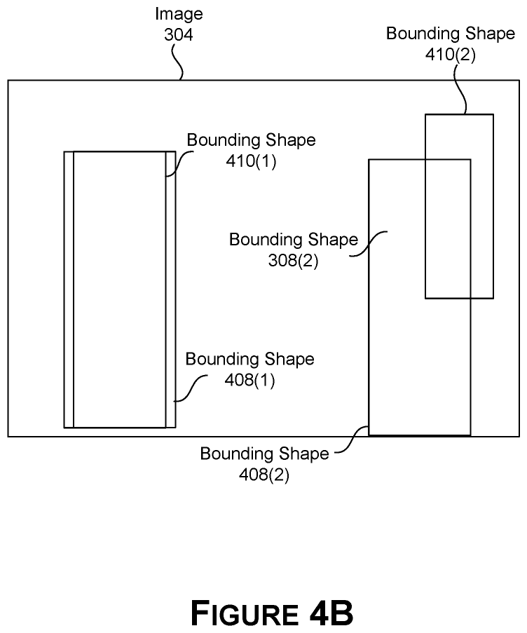

For instance, FIG. 4A illustrates a first example of tracking users between images, in accordance with some examples of the present disclosure. As shown, the detection component 110 may initially perform one or more of the processes described herein to determine body bounding shapes 402(1)-(2), head bounding shapes 404(1)-(2), and/or face bounding shapes 406(1)-(2) for two users detected in the image 304. The tracking component 120 may then determine a first amount of overlap between the predicted body bounding shape 306(1) and the detected body bounding shape 402(1) and/or a second amount of overlap between the predicted body bounding shape 306(1) and the detected body bounding shape 402(2). The tracking component 120 may then determine that the predicted body bounding shape 306(1) is associated with the determined body bounding shape 402(1) based on the first amount of overlap and the second amount of overlap. In some examples, the tracking component 120 makes the determination based on the first amount of overlap satisfying (e.g., being equal to or greater than) a threshold amount of overlap.

Additionally, the tracking component 120 may determine a first amount of overlap between the predicted head bounding shape 308(1) and the detected head bounding shape 404(1) and/or a second amount of overlap between the predicted head bounding shape 308(1) and the detected head bounding shape 404(2). The tracking component 120 may then determine that the predicted head bounding shape 308(1) is associated with the determined head bounding shape 404(1) based on the first amount of overlap and the second amount of overlap. In some examples, the tracking component 120 makes the determination based on the first amount of overlap satisfying a threshold amount of overlap. Furthermore, the tracking component 120 may determine a first amount of overlap between the predicted face bounding shape 310(1) and the detected face bounding shape 406(1) and/or a second amount of overlap between the predicted face bounding shape 310(1) and the detected face bounding shape 406(2) (which is not shown for clarity reasons). The tracking component 120 may then determine that the predicted face bounding shape 310(1) is associated with the determined face bounding shape 406(1) based on the first amount of overlap and the second amount of overlap. In some examples, the tracking component 120 makes the determination based on the first amount of overlap satisfying a threshold amount of overlap.

As such, the tracking component 120 may determine that the tracked user associated with the bounding shapes 306(1), 308(1), and 310(1) corresponds to the detected user associated with the bounding shapes 402(1), 404(1), and 406(1). In some examples, the tracking component 120 makes the determination based on at least one of the associations above. In some examples, the tracking component 120 makes the determination based on a specific one of the associations above (e.g., the body bounding shapes, the head bounding shapes, and/or the face bounding shapes). In either of the examples, the tracking component 120 may perform similar processes for each of the other tracked users.

In the example of FIG. 4A, based on performing these processes, the tracking component 120 may determine that the tracked user associated with the bounding shapes 306(2), 308(2), and 310(2) does not correspond to any of the detected users in the image 304. As such, the tracking component 120 may determine that the tracked user is not depicted in the image 304. Additionally, the tracking component 120 may determine that the detected user associated with the bounding shapes 402(2), 404(2), and 406(2) does not correspond to any of the tracked users. As such, the tracking component 120 may determine that the detected user is a new user.

FIG. 4B illustrates a second example of tracking users between images, in accordance with some examples of the present disclosure. In the example of FIG. 4B, the tracking component 120 (and/or another component) may have generated a final predicted bounding shape 408(1) for a tracked user using one or more of the bounding shapes 306(1), 308(1), and 310(1) and a final predicted bounding shape 408(2) for a tracked user using one or more of the bounding shapes 306(2), 308(2), and 310(2). The tracking component 120 may also generate a final detected bounding shape 410(1) for a detected user using one or more of the bounding shapes 402(1), 404(1), and 406(1) and a final detected bounding shape 410(2) for a detected user using one or more of the bounding shapes 404(2), 404(2), and 406(2).

The tracking component 120 may then determine a first amount of overlap between the final predicted bounding shape 408(1) and the final detected bounding shape 410(1) and/or a second amount of overlap between the final predicted bounding shape 408(1) and the final detected bounding shape 410(2). Additionally, the tracking component 120 may determine that the tracked user associated with the final predicted bounding shape 408(1) corresponds to the detected user associated with the final detected bounding shape 410(1) based on the first amount of overlap and/or the second amount of overlap. In some examples, the tracking component 120 may make the determination based on the first amount of overlap satisfying (e.g., being equal to or greater than) a threshold amount of overlap.

Additionally, in the example of FIG. 4B, the tracking component 120 may determine a first amount of overlap between the final predicted bounding shape 408(2) and the final detected bounding shape 410(1) and/or a second amount of overlap between the final predicted bounding shape 408(2) and the final detected bounding shape 410(2). The tracking component 120 may determine that the tracked user associated with the final predicted bounding shape 408(2) does not correspond to a detected user based on the first amount of overlap and/or the second amount of overlap. In some examples, the tracking component 120 may make the determination based on the first amount of overlap and the second amount of overlap not satisfying (e.g., being less than) a threshold amount of overlap. Furthermore, in the example of FIG. 4B, the tracking component 120 may determine that the detected user associated with the final detected bounding shape 410(2) includes a new user. In some examples, the tracking component 120 may make the determination based on the detected user not being associated with one of the tracked users.

Referring back to the example of FIG. 1, the process 100 may include a location component 130 that determines location information associated with tracked users. For instance, the location component 130 may include a 3D locator 132 that is configured to determine 3D locations of the tracked users within an environment. In some examples, and for a tracked user, the 3D locator 132 determines the 3D location based on one or more estimated 3D locations for the tracked user determined using the bounding shapes. For example, the 3D locator 132 may estimate a human pose (e.g., a body pose) by taking a 2D detection in the image space and then projecting a 3D pose for a human into the image sensor 106. When estimating the human pose using such a technique, the 3D locator 132 may use a 3D model of a human pose. Additionally, the 3D locator 132 may take a canonical pose and optimize the transition of the user until the projection of the 3D model into the image sensor 106 results in the 2D detected features. The 3D locator 132 may also estimate a 3D model for a head pose by projecting the 3D model into the image sensor 106 until facial landmarks match up with facial landmarks in the 2D image.

In some examples, the 3D locator 132 may use just the head pose to determine the 3D location of the user, such as when the user is within close range to the image sensor 106 (e.g., the image may not depict much of the body of the user). In some examples, the 3D locator 132 may use just the human pose to determine the 3D location of the user, such as when the user is too far away from the image sensor 106 (e.g., the features of the face as depicted in the image may be difficult to identify). Still, in some examples, the 3D locator 132 may use the head pose and the human pose to determine the 3D location of the user, such as when the user is within a middle range with respect to the image sensor 106. In such examples, the 3D locator 132 may determine the 3D location as an average of the head pose estimate and the human pose estimate.

In some examples, the 3D locations are represented in a coordinate system that is relative to the image sensor(s) 106. For instance, the 3D locations may be relative to the image sensor(s) 106. For a first example, and for a 3D location of a user, the 3D location may indicate a first distance along a first coordinate direction (e.g., the x-direction) relative to the image sensor(s) 106, a second distance along a second coordinate direction (e.g., the y-direction) relative of the image sensor(s) 106, and a third distance along a third coordinate direction (e.g., the z-direction) relative to the image sensor(s) 106. For a second example, and again for a 3D location of a user, the 3D location may indicate a distance to the user and an angle to the user that is with respect to the image sensor(s) 106.

In some examples, the 3D locator 132 may transform the 3D locations from the coordinate system that is relative of the image sensor(s) 106 to another coordinate system, such as a global coordinate system. In some examples, such as when there is noise associated with the head pose and/or the human pose, the 3D locator 132 may apply a filter, such as a Kalman filter, that takes a model of how a user is expected to move, and the actual measurements of 3D locations, and combines these into a model to smooth out the predicted position to get rid of some of the jitter in the final output. Still, in some examples, such as if a user is being tracked over a period of time, the 3D locator 132 may determine additional information associated with the user, such as a velocity of the user within the environment. In such examples, the 3D locator 132 may determine a positional velocity and/or an angular velocity associated with the user.

The location component 130 may include a zone locator 134 that is configured to associate tracked users with zones. As described herein, the zones associated with the device 102 may include, but are not limited to, an active zone, a passive near zone, a passive far zone, and/or an outer zone. The active zone may include an area of the environment that is closest to the device 102, the passive near zone may include an area of the environment that is further from the device 102 than the active zone, the passive far zone may include an area of the environment that is further from the device 102 than the active near zone, and the outer zone may include the rest of the environment. In some examples, the zone locator 134 associates the tracked users with the zones based on the 3D locations. For a first example, if a 3D location of a user is within the active zone, then the zone locator 134 may associate the user with the active zone. For a second example, if a 3D location of a user is within the passive far zone, then the zone locator 134 may associate the user with the passive far zone.

In some examples, the zone locator 134 may use one or more distance thresholds when associating the tracked users with the zones (e.g., the zone locator 134 may use hysteresis). The zone locator 134 may use the distance threshold(s) in order to avoid associating in quick succession a user with two different zones if the user is located between the two zones. As described herein, a distance threshold may include, but is not limited to, one meter, two meters, five meters, and/or any other distance. For example, the zone locator 134 may use a first distance threshold in order to switch from associating users with the passive near zone to the active zone. Additionally, the zone locator 134 may use a second distance threshold in order to switch from associating users with the active zone back to the passive near zone.

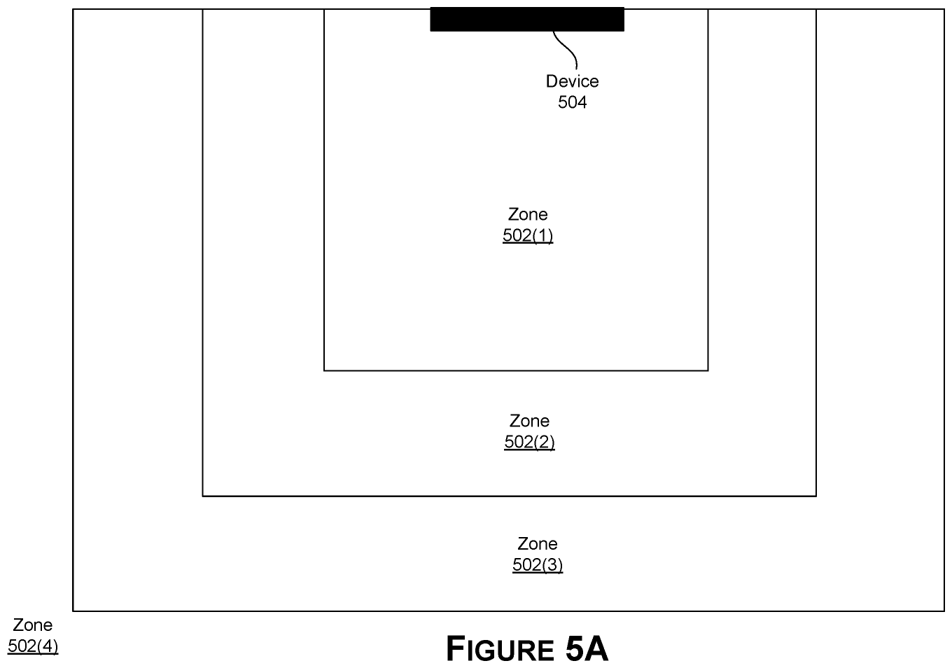

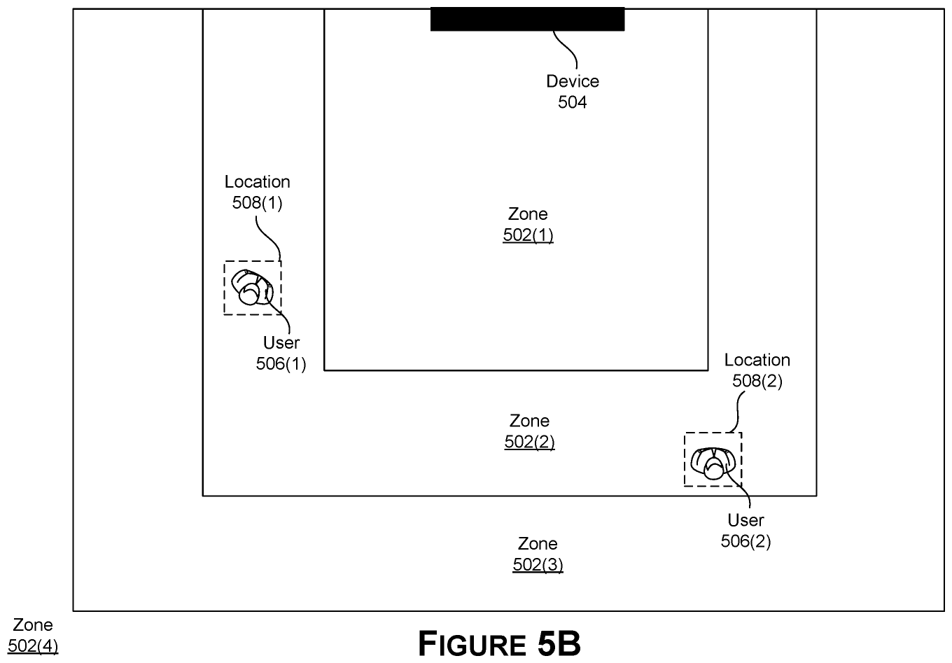

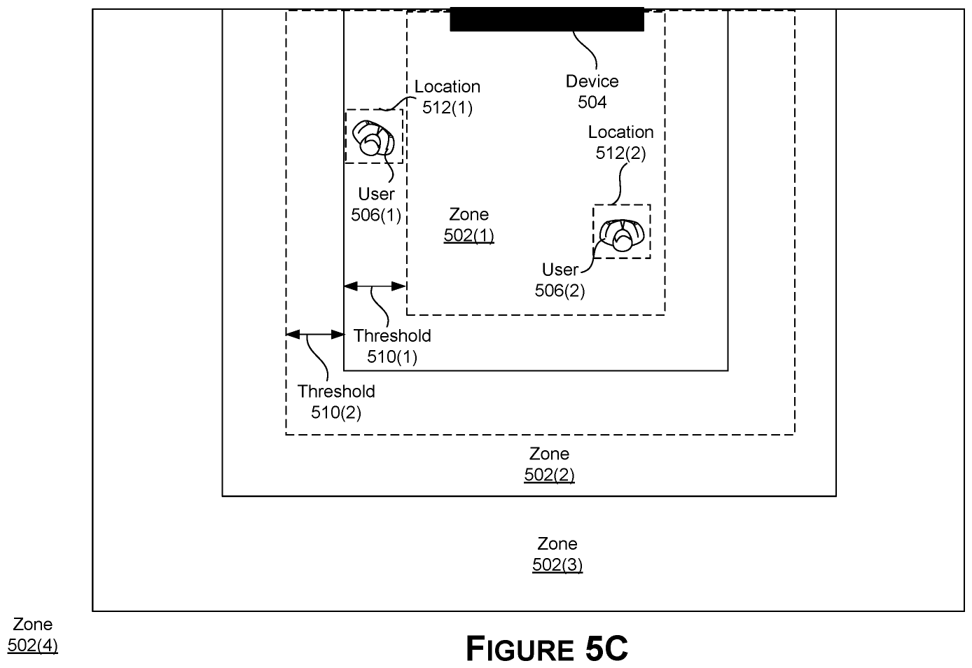

For instance, FIG. 5A illustrates an example of zones 502(1)-(4) associated with a device 504 (which may represent, and/or include, the device 102), in accordance with some embodiments of the present disclosure. In the example of FIG. 5A, the first zone 502(1) may include the active zone, the second zone 502(2) may include the passive near zone, the third zone 502(3) may include the passive far zone, and the fourth zone 502(4) may include the outer zone. While the example of FIG. 5A illustrates the zones 502(1)-(4) as being substantially rectangular in shape, in other examples, one or more of the zones 502(1)-(4) may include any other shape (e.g., a circle, a triangle, a square, a pentagon, etc.). Additionally, in some examples, one or more of the zones 502(1)-(4) may include a height such that the one or more zones 502(1)-(4) are volumetric (e.g., represented using cuboids or other 3D bounding shapes). Furthermore, while the example of FIG. 5B illustrates four zones 502(1)-(4), in other examples, the device 504 may be associated with any number of zones.

FIG. 5B illustrates an example of associating users 506(1)-(2) with the zones 502(1)-(4), in accordance with some embodiments of the present disclosure. For instance, in the example of FIG. 5B, the location component 130 (e.g., the 3D locator 132) may determine a first 3D location 508(1) associated with the first user 506(1) and a second 3D location 508(2) associated with the second user 506(2). The location component 130 (e.g., the zone locator 134) may then use the first 3D location 508(1) to determine that the first user 506(1) is located within the second zone 502(2) and the second 3D location 508(2) to determine that the second user 502(2) is also located within the second zone 502(2). As such, the location component 130 (e.g., the zone locator 134) may associate the first user 506(1) with the second zone 502(2) and associate the second user 502(2) with the second zone 502(2)

FIG. 5C illustrates an example of associating the users 506(1)-(2) with the zones 502(1)-(4) using distance threshold 510(1)-(2), in accordance with some embodiment of the present disclosure. For instance, in the example of FIG. 5C, the location component 130 (e.g., the 3D locator 132) may determine a first 3D location 512(1) associated with the first user 506(1) and a second 3D location 512(2) associated with the second user 506(2). The location component 130 (e.g., the zone locator 134) may then use the first 3D location 512(1) to determine that the first user 506(1) is located in the first zone 502(1). However, since the first 3D location 512(1) is within the distance threshold 510(1) associated with switching from the second zone 502(2) to the first zone 502(1), the location component 130 may continue to associate the first user 506(1) with the second zone 502(2). The location component 130 (e.g., the zone locator 134) may then use the second 3D location 512(2) to determine that the second user 506(2) is also located in the first zone 502(1). Additionally, since the second 3D location 512(2) is passed the distance threshold 510(1) associated with switching from the second zone 502(2) to the first zone 502(1), the location component 130 may associate the second user 506(2) with the first zone 502(1).

The example of FIG. 5C further illustrates another distance threshold 510(2) that is associated with switching from the first zone 502(1) to the second zone 502(2). For example, in order for the second user 506(2) to switch back to the second zone 502(2), the 3D location of the second user 506(2) would need to be within the second zone 502(2) by at least the distance threshold 510(2). While the example of FIG. 5C does not illustrates distance thresholds for switching between the second zone 502(2) and the third zone 502(3) and/or distance thresholds for switching between the third zone 502(3) and the fourth zone 502(4), in other examples, the location component 130 may use such distance thresholds similarly to the distance threshold 510(1)-(2).

Referring back to the example of FIG. 1, the process 100 may include a user component 136 that is configured to determine information associated with the tracked users. For instance, the user component 136 may include an overlapping detector 138 that is configured to select one user when two or more users are located proximate to one another. For example, the overlapping detector 138 may determine that at least a first user is located proximate to a second user. In some examples, the overlapping detector 138 makes the determination by determining one or more amounts over overlap between one or more of the bounding shapes associated with the first user and one or more corresponding bounding shapes associated with the second user. For example, the overlapping detector 138 may determine a first amount of overlap between a body bounding shape associated with the first user and a body bounding shape associated with the second user, a second amount of overlap between a head bounding shape associated with the first user and a head bounding shape associated with the second user, a third amount of overlap between a face bounding shape associated with the first user and a face bounding shape associated with the second user, and/or a fourth amount of overlap between a final bounding shape associated with the first user and a final bounding shape associated with the second user.

In some examples, the overlapping detector 138 may then determine that the first user is located proximate to the second user based on at least one of the amounts of overlap satisfying (e.g., being equal to or greater than) a threshold amount of overlap. In some examples, the overlapping detector 138 may then determine that the first user is located proximate to the second user based on two or more of the amounts of overlap satisfying (e.g., being equal to or greater than) a threshold amount of overlap. In either of the examples, the overlapping detector 138 may then select one of the users. For example, the overlapping detector 138 may select the user that is located closer to the device 102. In such an example, the overlapping detector 138 may determine that a user is located closer to the device 102 using the 3D locations associated with the users.

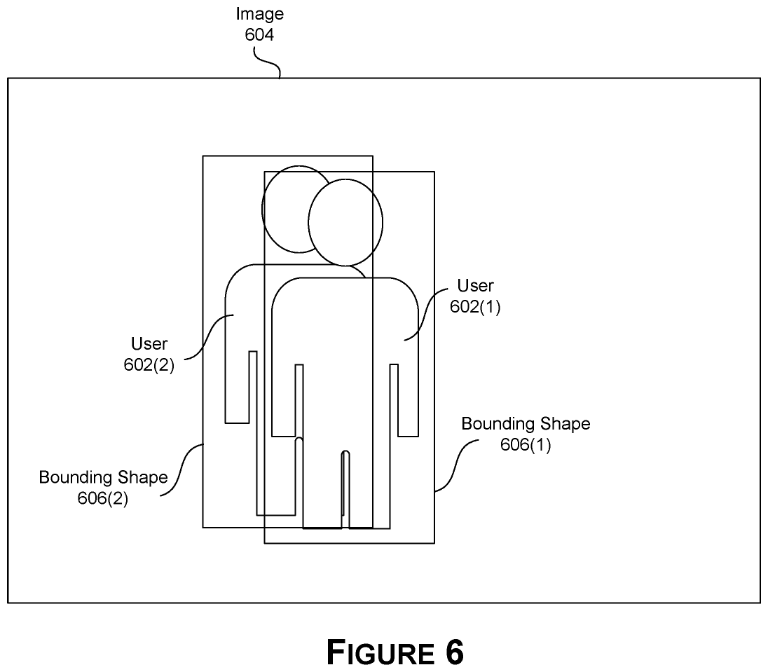

For instance, FIG. 6 illustrates an example of selecting a first user 602(1) when the first user 602(1) is located proximate to a second user 602(2), in accordance with some embodiments of the present disclosure. As shown, an image 604 depicts both the first user 602(1) and the second user 602(2). As such, the overlapping detector 138 may determine a first bounding shape 606(1) associated with the first user 602(1) and a second bounding shape 606(2) associated with the second user 602(2). The overlapping detector 138 may then determine an amount of overlap (e.g., using IoU) between the first bounding shape 606(1) and the second bounding shape 606(2). Additionally, the overlapping detector 138 may determine that the first user 602(1) is located proximate to the second user 602(2) based on the amount of overlap satisfying a threshold amount of overlap.

The overlapping detector 138 may then select one of the users 602(1)-(2) based on the determination. For instance, and in the example of FIG. 6, the overlapping detector 138 may use the 3D location associated with the first 602(1) and the 3D location associated with the second user 602(2) to determine that the first user 602(1) is located closer to the device than the second user 602(2). As such, in some examples the overlapping detector 138 may select the first user 602(1). In some examples, the overlapping detector 138 may further remove the second user 602(2) from the tracked list of users since the second user 602(2) is of less importance for the performance of the device, which is described in more detail herein.

Referring back to the example of FIG. 1, the user component 136 may include a primary detector 140 that is configured to select a primary user of the device 102. In some examples, such as when there is only a single tracked user, the primary detector 140 may select that user as the primary user of the device 102. In some examples, and again when there is only a single tracked user, the primary detector 140 may select the user as the primary user of the device 102 if the user is associated with one or more zones (e.g., the active zone or the passive near zone) associated with the device 102. In some examples, such as when there are multiple tracked users, the primary detector 140 may perform one or more processes to select one of the users as the primary user of the device 102. Still, in some examples, and again when there are multiple tracked users, the primary detector 140 may select one of the users as the primary user of the device 102 if the user is associated with one or more zones (e.g., the active zone or the passive near zone) associated with the device 102.

The primary detector 140 may use one or more techniques to select a user when there are multiple tracked users associated with the device 102. For instance, in some examples, the primary detector 140 may select the user that is closest to the device 102. In some examples, the primary detector 140 may select the user that is closest to a center of the device 102. In such examples, the primary detector 140 may determine the user that is closest to the center of the device 102 by projecting a line that is perpendicular to a center of the device 102 (e.g., a center of the display 108). The primary detector 140 may then determine distances between the users and the line and determine that the user that is associated with the shortest distance is the user that is the closest to the center of the device 102. Still, in some examples, the primary detector 140 may select the user that is closest to the center of the device and within a threshold distance to the device (e.g., located proximate to the device). While these are just a few example techniques for selecting a primary user, in other examples, the primary detector 140 may use additional and/or alternative techniques to select a primary user.

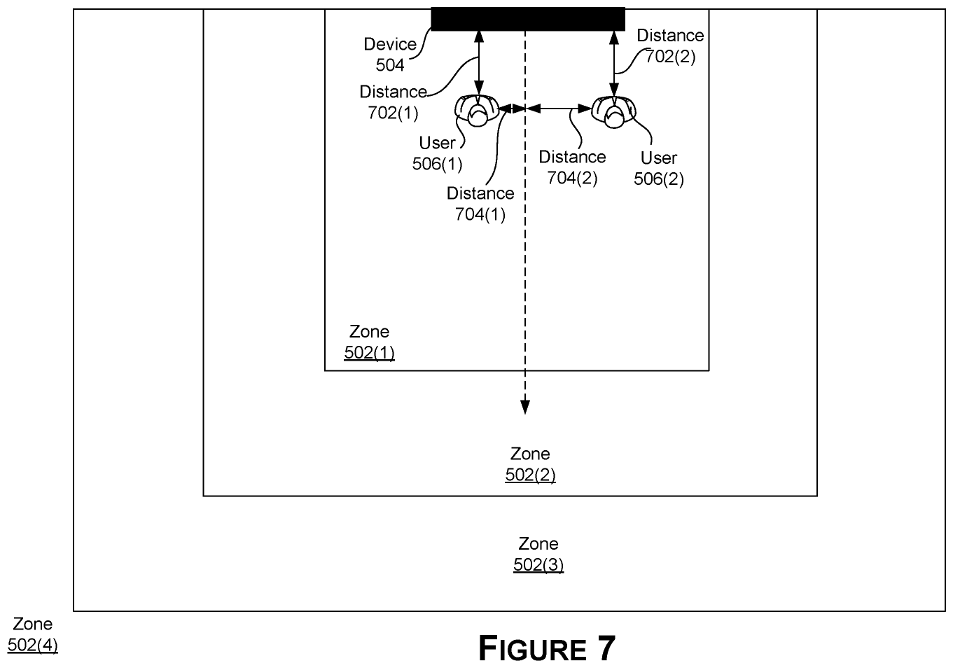

For instance, FIG. 7 illustrates an example of selecting a primary user, in accordance with some embodiments of the present disclosure. As shown, the user component 136 (e.g., the primary detector 140) may determine a distance 702(1) between the first user 506(1) and the device 504 and a distance 704(1) between the first user 506(1) and a center of the device 504 (e.g., a center of the display of the device 504, which is illustrated by the dashed arrow). The user component 136 may also determine a distance 702(2) between the second user 506(2) and the device 504 and a distance 704(2) between the second user 506(1) and the center of the device 504. The user component 136 may then select the first user 506(1) as the primary user based on one or more of the distances 702(1)-(2) and 704(1)-(2). For instance, in some examples, the user component 136 selects the first user 506(1) based on the first user 506(1) being located closer to the center of the device 504 even though both users 506(1)-(2) are located an approximately equal distance 702(1)-(2) from the device 504.

In some examples, to perform the processes of FIG. 7, the user component 136 may determine a first 3D location of the first user 506(1) and a second 3D location of the second user 506(2), such as by using one or more of the processes described herein. In such examples, the line perpendicular to the center of the device 504 may be “floating” in space. For instance, the first 3D location may indicate a distance along a first coordinate direction (e.g., the x-direction) relative to center of the device 504, a distance along a second coordinate direction (e.g., the y-direction) relative of the center of the device 504, and a distance along a third coordinate direction (e.g., the z-direction) relative to the center of the device 504. Additionally, the second 3D location may indicate a distance along the first coordinate direction (e.g., the x-direction) relative to center of the device 504, a distance along the second coordinate direction (e.g., the y-direction) relative of the center of the device 504, and the distance along a third coordinate direction (e.g., the z-direction) relative to the center of the device 504. The user component 136 may then determine the primary user using the 3D locations based on one or more of the processes described herein.

Referring back to the example of FIG. 1, the process 100 may include an attributes component 142 that is configured to determine attributes associated with one or more of the tracked users. In some examples, the attributes component 142 is configured to determine attributes associated with just the primary user. In some examples, the attributes component 142 is configured to determine attributes associated with all of the users. Still, in some examples, the attributes component 142 is configured to determine attributes associated with users that are located within one or more of the zones (e.g., the active zone and the passive near zone). As described herein, the attributes associated with a user may include, but are not limited to, an age of the user, an attentiveness of the user, whether the user is wearing a mask and/or other accessory on the face, an emotion of the user, a hair length of the user, a hair color of the user, a color(s) of one or more pieces of clothing of the user, a type(s) of one or more pieces of clothing of the user, and/or any other attribute associated with the user.

In some examples, the attributes component 142 may use the location of a user (e.g., the 2D location, the 3D location, etc.) when determining the attributes associated with the user. For instance, the attributes component 142 may use the location to determine a portion of an image to process, such as a portion of the image that depicts the user, when determining the attributes. Additionally, the attributes component 142 may process the image to detect specific attributes based on one or more criteria (e.g., distance, resolution, velocity, etc.) associated with the user. For a first example, if the user is located close to the device 102 such that the image does not depict the body of the user, then the attributes component 142 may process the image to determine attributes associated with the head of the user without processing the image to determine attributes associated with the clothing of the user. For a second example, if the user is located far from the device 102 such that the image may not depict many details of the head of the user, then the attributes component 142 may process the image to determine attributes associated with the clothes of the user without processing the image to determine attributes associated with the head of the user. This may help save computing resources by limiting the amount of data that is processed by the attributes component 142.

The attributes component 142 may then generate attributes data 144 representing the attributes associated with the user(s). While the example of FIG. 1 illustrates the attributes data 144 as being separate from the tracked-user data 128, in other examples, the attributes data 144 may be combined with and/or include part of the tracked-user data 128.

The process 100 may include an attentiveness component 146 that is configured to determine an attentiveness of one or more users located proximate to the device 102 (e.g., the display 108 of the device 102). In some examples, the attentiveness component 146 is configured to determine the attentiveness associated with just the primary user. In some examples, the attentiveness component 146 is configured to determine the attentiveness associated with all of the users. Still, in some examples, the attentiveness component 146 is configured to determine the attentiveness associated with users that are located within one or more of the zones (e.g., the active zone and the passive near zone). As described herein, attentiveness may measure whether a user is looking at and/or focusing on the device 102 (e.g., content being displayed by the display 108), interacting with the device 102 (e.g., interacting with the content being displayed), and/or the like.

The attentiveness component 146 may use one or more techniques to determine the attentiveness. For a first example, and for a user that is located in front of the device 102 (e.g., in front of the sides of the display 108), the attentiveness component 146 may use a first technique to determine the attentiveness of the user. For instance, the attentiveness component 146 may determine a first vector that is perpendicular to the device 102 (e.g., the display 108) and a second vector associated with the orientation of the head of the user. The attentiveness component 146 may then use the vectors to determine the attentiveness of the user. For instance, and in some examples, the attentiveness component 146 may determine a difference between the vectors (e.g., the angle between the vectors) and then use the difference to determine whether the user is focusing on the device 102 (e.g., on the display 108) or whether the user is focusing on a location that is outside of the device 102.

For a second example, and for a user that is not located in front of the device 102, the attentiveness component 146 may use a second technique to determine the attentiveness of the user. For instance, the attentiveness component 146 may determine a first vector from an edge of the device 102 (e.g., an edge of the display 108) to the head of the user and a second vector associated with the orientation of the head of the user. The attentiveness component 146 may then use the vectors to determine the attentiveness of the user. For instance, and in some examples, the attentiveness component 146 may determine a difference between the vectors (e.g., the angle between the vectors) and then use the difference to determine whether the user is focusing on the device 102 (e.g., on the display 108) or whether the user is focusing on a location that is outside of the device 102.

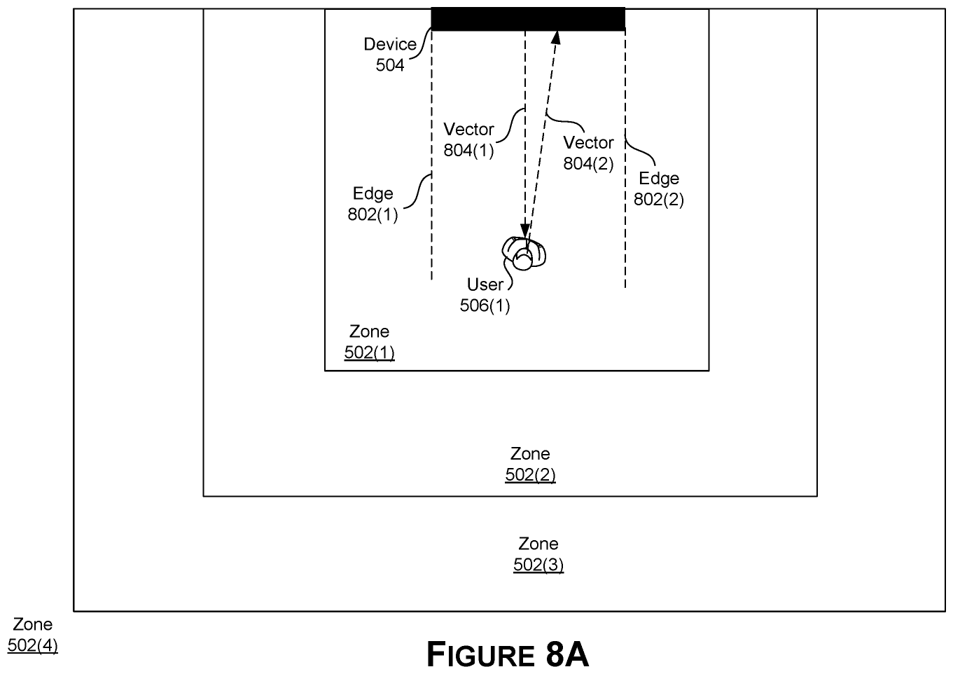

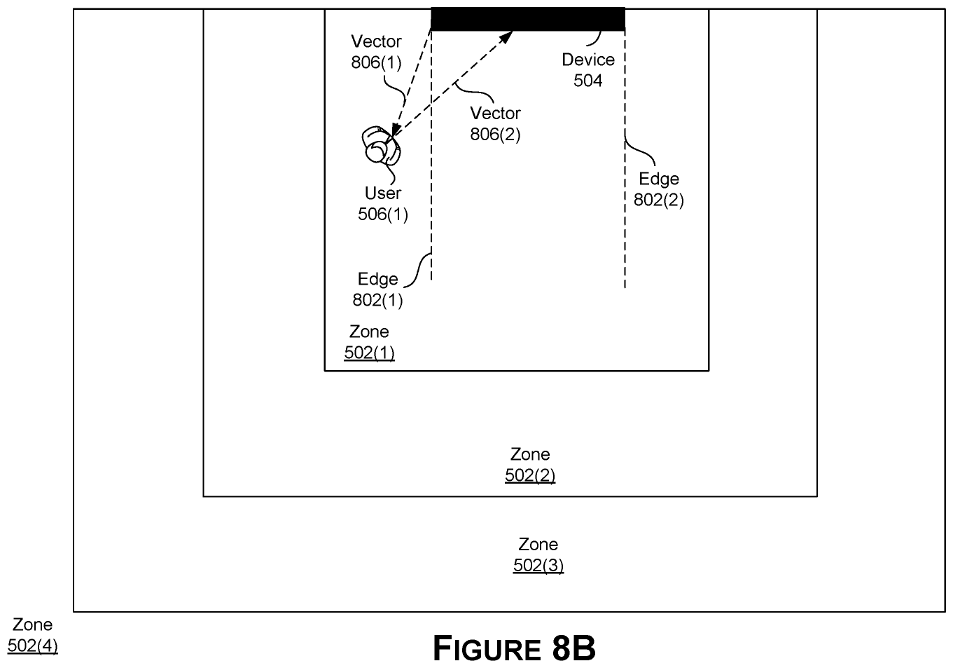

For instance, FIG. 8A illustrates a first example of determining an attentiveness of a user, in accordance with some embodiments of the present disclosure. In the example of FIG. 8A, the attentiveness component 146 may determine that the user 506(1) is located in front of the device 504 (e.g., in front of the display of the device 504) based on the user 506(1) being located within edges 802(1)-(2) of the device 504 (and/or the edges 802(1)-(2) of the display of the device 504). As such, the attentiveness component 146 may determine a first vector 804(1) that is perpendicular from the device 504 (e.g., from the display of the device 504) and a second vector 804(2) associated with an orientation of the head of the user 506(1). The attentiveness component 146 may then determine the attentiveness of the user 506(1) based on the first vector 804(1) and the second vector 804(2).

For example, the attentiveness component 146 may “flip” the first vector 804(1) such that the first vector 804(1) and the second vector 804(2) point away from the user 506(1). The attentiveness component 146 may then determine an angle between the first vector 804(1) and the second vector 804(2). Additionally, the attentiveness component 146 may use a threshold angle to determine whether the user 506(1) is attentive or not. As described herein, the threshold angle may include, but is not limited to, 5 degrees, 10 degrees, 20 degrees, and/or any other angle. In some examples, in order to avoid jitter and quick succession of changes back and forth between being attentive and not attentive, the attentiveness component 146 may use one or more hysteresis methods.

FIG. 8B illustrates a second example of determining an attentiveness of a user, in accordance with some embodiments of the present disclosure. In the example of FIG. 8B, the attentiveness component 146 may determine that the user 506(1) is not located in front of the device 504 (e.g., not located in front of the display of the device 504) based on the user 506(1) being located outside of the edges 802(1)-(2) of the device 504 (and/or outside the edges 802(1)-(2) of the display of the device 504). As such, the attentiveness component 146 may determine a first vector 806(1) that is from an edge 802(1) of the device 504 to the head of the user 506(1) and a second vector 806(2) associated with an orientation of the head of the user 506(1). The attentiveness component 146 may then determine the attentiveness of the user 506(1) based on the first vector 806(1) and the second vector 806(2).

For example, the attentiveness component 146 may “flip” the first vector 806(1) such that the first vector 806(1) and the second vector 806(2) point away from the user 506(1). The attentiveness component 146 may then determine an angle between the first vector 806(1) and the second vector 806(2). Additionally, the attentiveness component 146 may use a threshold angle to determine whether the user 506(1) is attentive or not. Again, as described herein, the threshold angle may include, but is not limited to, 5 degrees, 10 degrees, 20 degrees, and/or any other angle. In some examples, in order to avoid jitter and quick succession of changes back and forth between being attentive and not attentive, the attentiveness component 146 may use one or more hysteresis methods.

Referring back to the example of FIG. 1, in some examples, the attentiveness component 146 may use the vectors to determine that the user is either attentive to the device 102 (e.g., focusing on and/or looking at the display 108) or not attentive to the device 102 (e.g., not focusing on and/or not looking at the display 108). In such examples, the attentiveness component 146 may generate and then output attention data 148 representing a first value when the user is attentive and a second value when the user is not attentive.

However, in some examples, the attentiveness component 146 may use the vectors to determine an amount of attentiveness associated with the user. In such examples, the attentiveness component 146 may generate and then output attention data 148 representing a value that is within a range, where the lowest value in the range is associated with the user not paying any attention to the device 102, the highest value in the range is associated with the user paying complete attention to the device 102, and a value between the lowest value and the highest value being associated with how much attention the user is paying to the device 102. In such examples, the attentiveness component 146 may determine the value by the following formula:

$$value = \frac{90 ° - angle}{90 °} \qquad ( 1 )$$

In equation (1), angle may include the angle between the vectors, which is described herein.

In some examples, the attentiveness component 146 may perform additional and/or alternative techniques when determining the attentiveness of users. For a first example, if the attentiveness component 146 is processing image data 104 representing an image that does not depict the head of the user (e.g., the user is very close to the image sensor(s) 106 such that the image does not depict the head of the user), then the attentiveness component 146 may use a vector associated with an orientation of the body of the user when determining the attentiveness rather than the vector associated with the orientation of the head of the user. For a second example, such as when the image data 104 being processed by the attentiveness component 146 represents an image depicting one or more eyes of a user, the attentiveness component 146 may determine a gaze vector associated with the user. The attentiveness component 146 may then use the gaze vector to determine the attentiveness of the user. In such an example, the attentiveness component 146 may use the gaze vector in addition to, or alternatively from, using the vectors.

As shown, and as described herein, the attentiveness component 146 may generate and then output the attention data 148 representing attentiveness of one or more users. While the example of FIG. 1 illustrates the attention data 148 as being separate from the tracked-user data 128, in other examples, the attention data 148 may be combined with and/or include part of the tracked-user data 128.

The process 100 may include an output component 150 that is configured to provide content to users. In some examples, the output provided by the device 102 may include an interactive avatar that interacts with users located proximate to the device 102. For example, the avatar may use the locations of the users to focus on the users when interacting. The avatar may also communicate with the users. For example, if the user asks the avatar a question, then the avatar may provide a response to the question. While this is just one type of content that may be provided by the device 102, in other examples, the device 102 may provide any other type of content to users.

In some examples, the output component 150 may only cause the device 102 to output content based on the occurrence of one or more events. For a first example, the output component 150 may cause the device to output content based on at least one user being located in one or more of the zones, such as the active zone, the passive near zone, and/or the like. For a second examples, the output component 150 may cause the device 102 to output content based on at least one user being attentive to the device 102 (e.g., including an attentiveness value that satisfies a threshold value). Still, for a third example, the output component 150 may cause the device 102 to output content based on at least one user actively interacting with the device 102, such as through speech. While these are just a couple example events for which the output component 150 may cause the device 102 to output content, in other examples, the output component 150 may cause the device 102 to output content based on additional and/or alternative events.

In some examples, the process 100 may continue to repeat as the device 102 continues to generate image data 104 representing the environment around the device 102. For example, the detection component 110 may continue to detect users, the prediction component 118 may continue to predict the motion of users, the tracking component 120 may continue to track users, the location component 130 may continue to determine the locations of users, the user component 136 may continue to determine the primary users, the attributes component 142 may continue to determine the attributes of users, the attentiveness component 146 may continue to determine the attentiveness of users, and/or the output component 150 may continue to cause the device 102 to output content. In some examples, the components may also continue to generate and/or update the data described herein while performing the process 100 described herein.

While the example of FIG. 1 illustrates the detection component 110, the prediction component 118, the tracking component 120, the location component 130, the user component 136, the attributes component 142, the attentiveness component 146, and the output component 150 as being separate from the device 102, in some examples, one or more of the detection component 110, the prediction component 118, the tracking component 120, the location component 130, the user component 136, the attributes component 142, the attentiveness component 146, and the output component 150 may be included in the device 102.

As described herein, one or more of the components (e.g., the detection component 110, the prediction component 118, the tracking component 120, the location component 130, the user component 136, the attributes component 142, the attentiveness component 146, and/or the output component 150), one or more of the detectors (e.g., the body detector 112, the head detector 114, the face detector 116, the overlapping detector 138, and/or the primary detector 140), one or more of the trackers (e.g., the body tracker 122, the head tracker 124, and/or the face tracker 126), and/or one or more of the locators (e.g., the 3D locator 132 and/or the zone locator 134) may use one or more machine learning models, one or more neural networks, one or more algorithms, and/or the like to perform the processes described herein.

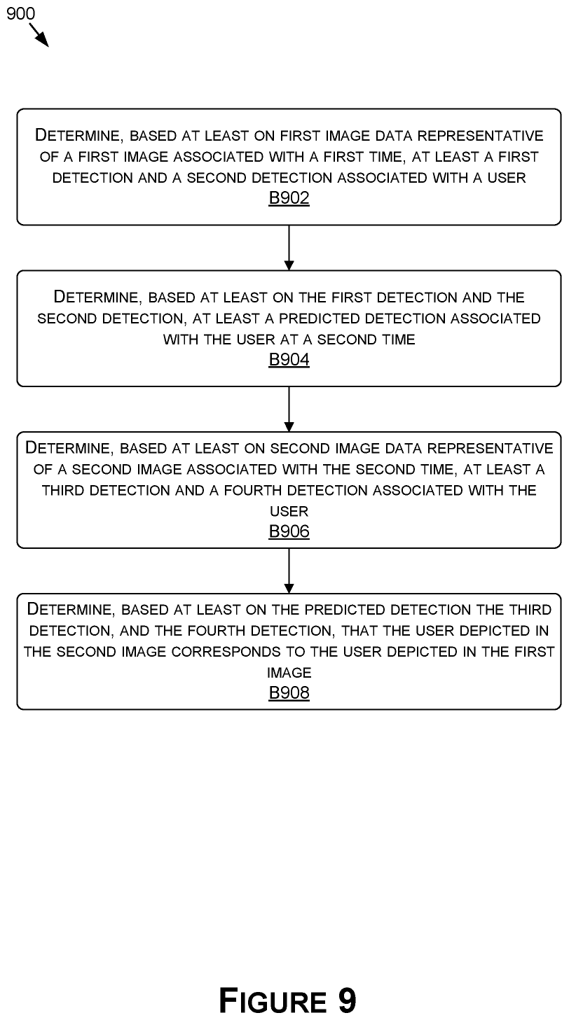

Now referring to FIGS. 9-12, each block of methods 900, 1000, 1100, and 1200, described herein, comprises a computing process that may be performed using any combination of hardware, firmware, and/or software. For instance, various functions may be carried out by a processor executing instructions stored in memory. The methods 900, 1000, 1100, and 1200 may also be embodied as computer-usable instructions stored on computer storage media. The methods 900, 1000, 1100, and 1200 may be provided by a standalone application, a service or hosted service (standalone or in combination with another hosted service), or a plug-in to another product, to name a few. In addition, the methods 900, 1000, 1100, and 1200 are described, by way of example, with respect to FIG. 1. However, these methods 900, 1000, 1100, and 1200 may additionally or alternatively be executed by any one system, or any combination of systems, including, but not limited to, those described herein.

FIG. 9 is a flow diagram showing a method 900 for tracking a user between images, in accordance with some embodiments of the present disclosure. The method 900, at block B902, may include determining, based at least on first image data representative of a first image associated with a first time, at least a first detection and a second detection associated with a user. For instance, the detection component 110 may process the image data 104 using one or more of the body detector 112, the head detector 114, or the face detector 116. Based on the processing, the detection component 110 may determine the first detection and the second detection associated with the user. For a first example, the first detection may include key points and/or a skeleton associated with the user determined using the body detector 112 and the second detection may include a bounding shape associated with the head of the user determined using the head detector 114. For a second example, the first detection may again include the key points and/or the skeleton associated with the user and the second detection may include a bounding shape associated with the face of the user.

The method 900, at block B904, may include determining, based at least on the first detection and the second detection, at least a predicted detection associated with the user at a second time. For instance, the prediction component 118 may use the first detection and the second detection associated with the first time (and/or one or more additional detections associated with one or more previous times) to determine the predicted detection. For example, the predicted detection may include a predicted bounding shape associated with the body of the user at the second time, a predicted bounding shape associated with the head of the user at the second time, a predicted bounding shape associated with the face of the user at the second time, and/or a predicted bounding shape associated with the user at the second time.

The method 900, at block B906, may include determining, based at least on second image data representative of a second image associated with a second time, at least a third detection and a fourth detection associated with the user. For instance, the detection component 110 may process the image data 104 using one or more of the body detector 112, the head detector 114, or the face detector 116. Based on the processing, the detection component 110 may determine the third detection and the fourth detection associated with the user. For a first example, the third detection may include key points and/or a skeleton associated with the user determined using the body detector 112 and the fourth detection may include a bounding shape associated with the head of the user determined using the head detector 114. For a second example, the third detection may again include the key points and/or the skeleton associated with the user and the fourth detection may include a bounding shape associated with the face of the user.

The method 900, at block B908, may include determining, based at least on the predicted detection, the third detection, and the fourth detection, that the user depicted in the second image corresponds to the user depicted in the first image. For instance, the tracking component 120 may use the predicted detection(s) and the new detections to determine that the user depicted in the second image corresponds to the user depicted in the first image. In some examples, the tracking component 120 may make the determination based on an amount(s) of overlaps between the predicted detection(s) and the new detections.

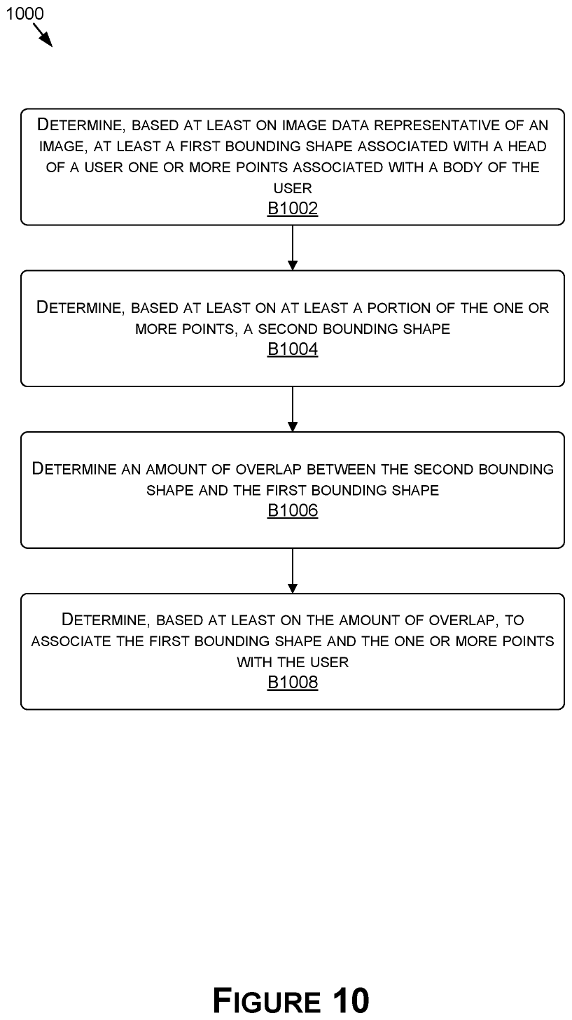

FIG. 10 is a flow diagram showing a method 1000 for merging detections associated with users, in accordance with some embodiments of the present disclosure. The method 1000, at block B1002, may include determining, based at least on image data representative of an image, at least a first bounding shape associated with a head of a user and one or more points associated with a body of the user. For instance, the detection component 110 may process the image data 1004. Based on the processing, the detection component 110 may determine the first bounding shape using the head detector 114 and the one or more points using the body detector 112. In some examples, based on the processing, the detection component 110 may further determine a bounding shape associated with a face of the user using the face detector 116.

The method 1000, at block B1004, may include determining, based at least on at least a portion of the one or more points, a second bounding shape. For instance, the detection component 110 may use at least the point(s) that are associated with the head of the user to determine the second bounding shape.

The method 1000, at block B1006, may include determining an amount of overlap between the second bounding shape and the first bounding shape. For instance, the detection component 110 may determine the amount of overlap between the second bounding shape and the first bounding shape. In some examples, the detection component 110 may further determine a second amount of overlap between the second bounding shape and the bounding shape associated with the face of the user.

The method 1000, at block B1008, may include determining, based at least on the amount of overlap, to associate the first bounding shape and the one or more points with the user. For instance, detection component 110 may determine that the amount of overlap satisfies (e.g., is equal to or greater than) a threshold amount of overlap. As such, the detection component 110 may determine that the first bounding shape and the one or more points are associated with the same user. In some examples, the detection component 110 may further determine that the second amount of overlap satisfies (e.g., is equal to or greater than) the threshold amount of overlap. The detection component 110 may then further associate the bounding shape associated with the face of the user with the first bounding shape and/or the one or more points.

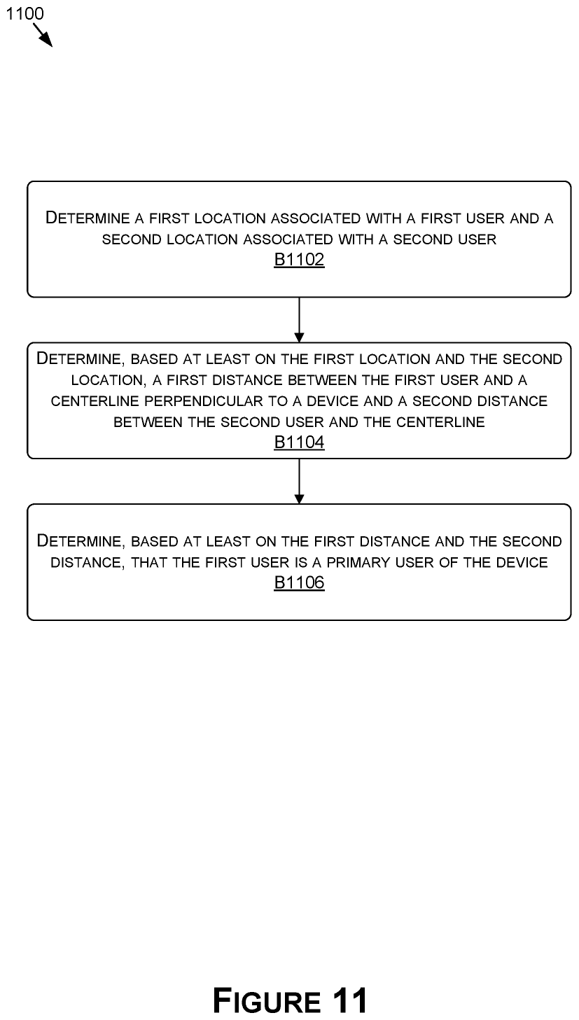

FIG. 11 is a flow diagram showing a method 1100 for determining a primary user of a device, in accordance with some embodiments of the present disclosure. The method 1100, at block B1102, may include determining a first location associated with a first user and a second location associated with a second user. For instance, the location component 130 may determine a first 2D location associated with the first user and a second 2D location associated with the second user. The location component 130 may then use the 2D locations to determine a first 3D location associated with the first user and a second 3D location associated with the second user within an environment.

The method 1100, at block B1104, may include determining, based at least on the first location and the second location, a second distance between the first user and a centerline perpendicular to a device and a second distance between the second user and the centerline. For instance, the user component 136 may use the first location associated with the first user to determine the first distance between the first user and the centerline associated with the device 102 (e.g., the centerline associated with the display 108 of the device 102). The user component 136 may also use the second location associated with the second user to determine the second distance between the second user and the centerline associated with the device 102 (e.g., the centerline associated with the display 108 of the device 102).

The method 1100, at block B1106, may include determining, based at least on the first distance and the second distance, that the first user is a primary user of the device. For instance, the user component 136 may use the first distance and the second distance to determine that the first user is the primary user. For example, the user component 136 may use the first distance and the second distance to select the first user based on the first user being closer to the centerline of the device. In some examples, the user component 136 may use such a process to select the first user based on the first user and the second user being within a threshold distance to the device 102. In some examples, the user component 136 may use such a process to select the first user based on the first user and the second user being within the same zone relative to the device 102.

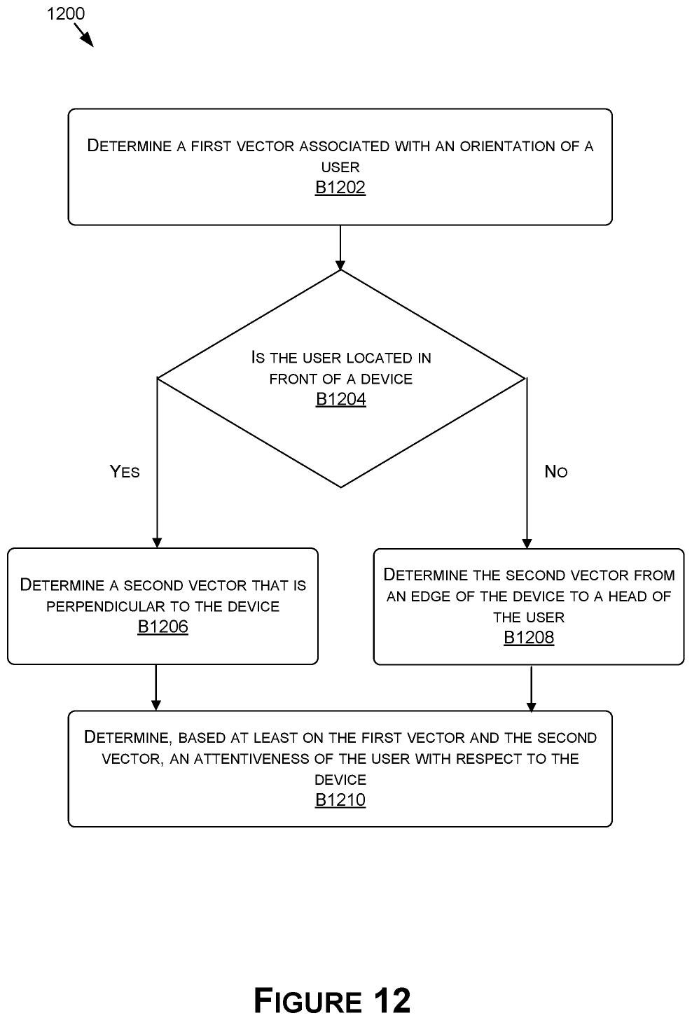

FIG. 12 is a flow diagram showing a method 1200 for determining an attentiveness of a user with respect to a display, in accordance with some embodiments of the present disclosure. The method 1200, at block B1202, may include determining a first vector associated with an orientation of a user. For instance, the attentiveness component 146 may determine the first vector that is associated with the orientation of the user. In some examples, such as when the head of the user is depicted in an image, the attentiveness component 146 may determine the first vector as being associated with the orientation of the head of the user. In some examples, such as when the head of the user is not depicted in the image, the attentiveness component 146 may determine the first vector as being associated with the orientation of the body of the user.

The method 1200, at block B1204, may include determining whether the user is located in front of a device. For instance, the attentiveness component 146 may determine if the user is located in front of the device 102 (and/or the display 108 of the device 102). In some examples, the attentiveness component 146 determines that the user is located in front of the device 102 based on the user being located within the edges of the device 102 (e.g., the edges of the display 108 of the device 102) and determine that the user is not located in front of the device 102 based on the user being located outside of the edges of the device 102 (e.g., the edges of the display 108 of the device 102).

If, at block B1204, it is determined that the user is located in front of the device, then the method 1200, at block B1206, may include determining a second vector that is perpendicular to the device. For instance, if the attentiveness component 146 determines that the user is located in front of the device 102, then the attentiveness component 146 may determine the second vector as being perpendicular to the device 102 (e.g., perpendicular to the display 108 of the device 102).

However, if, at block B1204, it is determined that the user is not located in front of the device, then the method 1200, at block B1208, may include determining the second vector from an edge of the device to a head of the user. For instance, if the attentiveness component 146 determines that the user is not located in front of the device 102, then the attentiveness component 146 may determine the second vector going from the edge of the device 102 (e.g., an edge of the display 108 of the device 102) to the head of the user.

The method 1200, at block B1210, may include determining, based at least on the first vector and the second vector, an attentiveness of the user with respect to the device. For instance, the attentiveness component 146 may use the first vector and the second vector to determine the attentiveness of the user with respect to the device 102 (e.g., the display 108 of the device 102). In some examples, the attentiveness component 146 may output a first value indicating that the user is attentive or a second value indicating that the user is not attentive. In some examples, the attentiveness component 146 may output a value that falls within a range of attentiveness.

### Example Computing Device

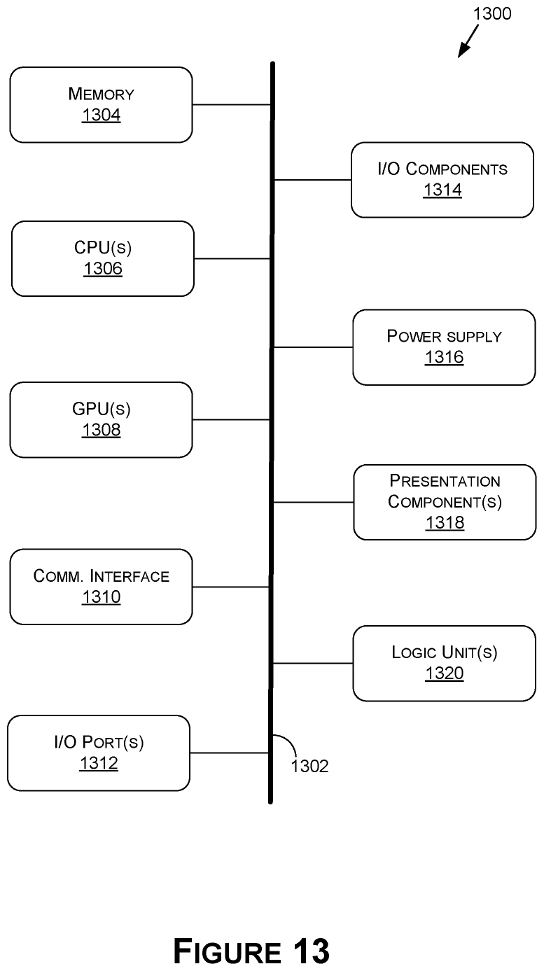

FIG. 13 is a block diagram of an example computing device(s) 1300 suitable for use in implementing some embodiments of the present disclosure. Computing device 1300 may include an interconnect system 1302 that directly or indirectly couples the following devices: memory 1304, one or more central processing units (CPUs) 1306, one or more graphics processing units (GPUs) 1308, a communication interface 1310, input/output (I/O) ports 1312, input/output components 1314, a power supply 1316, one or more presentation components 1318 (e.g., display(s)), and one or more logic units 1320. In at least one embodiment, the computing device(s) 1300 may comprise one or more virtual machines (VMs), and/or any of the components thereof may comprise virtual components (e.g., virtual hardware components). For non-limiting examples, one or more of the GPUs 1308 may comprise one or more vGPUs, one or more of the CPUs 1306 may comprise one or more vCPUs, and/or one or more of the logic units 1320 may comprise one or more virtual logic units. As such, a computing device(s) 1300 may include discrete components (e.g., a full GPU dedicated to the computing device 1300), virtual components (e.g., a portion of a GPU dedicated to the computing device 1300), or a combination thereof.

Although the various blocks of FIG. 13 are shown as connected via the interconnect system 1302 with lines, this is not intended to be limiting and is for clarity only. For example, in some embodiments, a presentation component 1318, such as a display device, may be considered an I/O component 1314 (e.g., if the display is a touch screen). As another example, the CPUs 1306 and/or GPUs 1308 may include memory (e.g., the memory 1304 may be representative of a storage device in addition to the memory of the GPUs 1308, the CPUs 1306, and/or other components). In other words, the computing device of FIG. 13 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 13.

The interconnect system 1302 may represent one or more links or busses, such as an address bus, a data bus, a control bus, or a combination thereof. The interconnect system 1302 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1306 may be directly connected to the memory 1304. Further, the CPU 1306 may be directly connected to the GPU 1308. Where there is direct, or point-to-point connection between components, the interconnect system 1302 may include a PCIe link to carry out the connection. In these examples, a PCI bus need not be included in the computing device 1300.

The memory 1304 may include any of a variety of computer-readable media. The computer-readable media may be any available media that may be accessed by the computing device 1300. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1304 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1300. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1306 may be configured to execute at least some of the computer-readable instructions to control one or more components of the computing device 1300 to perform one or more of the methods and/or processes described herein. The CPU(s) 1306 may each include one or more cores (e.g., one, two, four, eight, twenty-eight, seventy-two, etc.) that are capable of handling a multitude of software threads simultaneously. The CPU(s) 1306 may include any type of processor, and may include different types of processors depending on the type of computing device 1300 implemented (e.g., processors with fewer cores for mobile devices and processors with more cores for servers). For example, depending on the type of computing device 1300, the processor may be an Advanced RISC Machines (ARM) processor implemented using Reduced Instruction Set Computing (RISC) or an x86 processor implemented using Complex Instruction Set Computing (CISC). The computing device 1300 may include one or more CPUs 1306 in addition to one or more microprocessors or supplementary co-processors, such as math co-processors.

In addition to or alternatively from the CPU(s) 1306, the GPU(s) 1308 may be configured to execute at least some of the computer-readable instructions to control one or more components of the computing device 1300 to perform one or more of the methods and/or processes described herein. One or more of the GPU(s) 1308 may be an integrated GPU (e.g., with one or more of the CPU(s) 1306 and/or one or more of the GPU(s) 1308 may be a discrete GPU. In embodiments, one or more of the GPU(s) 1308 may be a coprocessor of one or more of the CPU(s) 1306. The GPU(s) 1308 may be used by the computing device 1300 to render graphics (e.g., 3D graphics) or perform general purpose computations. For example, the GPU(s) 1308 may be used for General-Purpose computing on GPUs (GPGPU). The GPU(s) 1308 may include hundreds or thousands of cores that are capable of handling hundreds or thousands of software threads simultaneously. The GPU(s) 1308 may generate pixel data for output images in response to rendering commands (e.g., rendering commands from the CPU(s) 1306 received via a host interface). The GPU(s) 1308 may include graphics memory, such as display memory, for storing pixel data or any other suitable data, such as GPGPU data. The display memory may be included as part of the memory 1304. The GPU(s) 1308 may include two or more GPUs operating in parallel (e.g., via a link). The link may directly connect the GPUs (e.g., using NVLINK) or may connect the GPUs through a switch (e.g., using NVSwitch). When combined together, each GPU 1308 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1306 and/or the GPU(s) 1308, the logic unit(s) 1320 may be configured to execute at least some of the computer-readable instructions to control one or more components of the computing device 1300 to perform one or more of the methods and/or processes described herein. In embodiments, the CPU(s) 1306, the GPU(s) 1308, and/or the logic unit(s) 1320 may discretely or jointly perform any combination of the methods, processes and/or portions thereof. One or more of the logic units 1320 may be part of and/or integrated in one or more of the CPU(s) 1306 and/or the GPU(s) 1308 and/or one or more of the logic units 1320 may be discrete components or otherwise external to the CPU(s) 1306 and/or the GPU(s) 1308. In embodiments, one or more of the logic units 1320 may be a coprocessor of one or more of the CPU(s) 1306 and/or one or more of the GPU(s) 1308.

Examples of the logic unit(s) 1320 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1310 may include one or more receivers, transmitters, and/or transceivers that enable the computing device 1300 to communicate with other computing devices via an electronic communication network, included wired and/or wireless communications. The communication interface 1310 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1320 and/or communication interface 1310 may include one or more data processing units (DPUs) to transmit data received over a network and/or through interconnect system 1302 directly to (e.g., a memory of) one or more GPU(s) 1308.

The I/O ports 1312 may enable the computing device 1300 to be logically coupled to other devices including the I/O components 1314, the presentation component(s) 1318, and/or other components, some of which may be built in to (e.g., integrated in) the computing device 1300. Illustrative I/O components 1314 include a microphone, mouse, keyboard, joystick, game pad, game controller, satellite dish, scanner, printer, wireless device, etc. The I/O components 1314 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1300. The computing device 1300 may be include depth cameras, such as stereoscopic camera systems, infrared camera systems, RGB camera systems, touchscreen technology, and combinations of these, for gesture detection and recognition. Additionally, the computing device 1300 may include accelerometers or gyroscopes (e.g., as part of an inertia measurement unit (IMU)) that enable detection of motion. In some examples, the output of the accelerometers or gyroscopes may be used by the computing device 1300 to render immersive augmented reality or virtual reality.

The power supply 1316 may include a hard-wired power supply, a battery power supply, or a combination thereof. The power supply 1316 may provide power to the computing device 1300 to enable the components of the computing device 1300 to operate.

The presentation component(s) 1318 may include a display (e.g., a monitor, a touch screen, a television screen, a heads-up-display (HUD), other display types, or a combination thereof), speakers, and/or other presentation components. The presentation component(s) 1318 may receive data from other components (e.g., the GPU(s) 1308, the CPU(s) 1306, DPUs, etc.), and output the data (e.g., as an image, video, sound, etc.).

EXAMPLE DATA CENTER

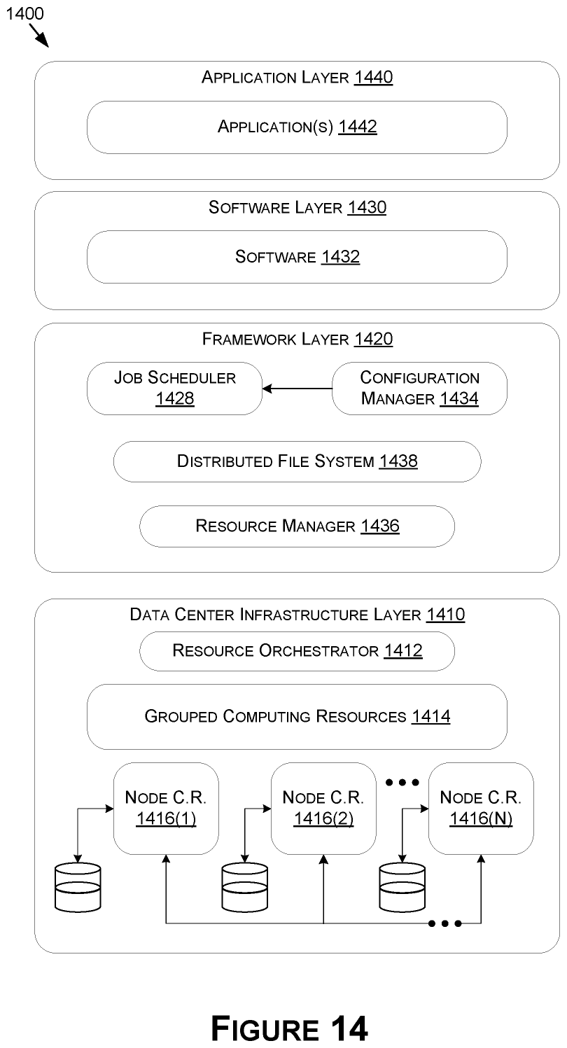

FIG. 14 illustrates an example data center 1400 that may be used in at least one embodiments of the present disclosure. The data center 1400 may include a data center infrastructure layer 1410, a framework layer 1420, a software layer 1430, and/or an application layer 1440.

As shown in FIG. 14, the data center infrastructure layer 1410 may include a resource orchestrator 1412, grouped computing resources 1414, and node computing resources (“node C.R.s”) 1416(1)-1416(N), where “N” represents any whole, positive integer. In at least one embodiment, node C.R.s 1416(1)-1416(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1416(1)-1416(N) may correspond to a server having one or more of the above-mentioned computing resources. In addition, in some embodiments, the node C.R.s 1416(1)-14161(N) may include one or more virtual components, such as vGPUs, vCPUs, and/or the like, and/or one or more of the node C.R.s 1416(1)-1416(N) may correspond to a virtual machine (VM).

In at least one embodiment, grouped computing resources 1414 may include separate groupings of node C.R.s 1416 housed within one or more racks (not shown), or many racks housed in data centers at various geographical locations (also not shown). Separate groupings of node C.R.s 1416 within grouped computing resources 1414 may include grouped compute, network, memory or storage resources that may be configured or allocated to support one or more workloads. In at least one embodiment, several node C.R.s 1416 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1412 may configure or otherwise control one or more node C.R.s 1416(1)-1416(N) and/or grouped computing resources 1414. In at least one embodiment, resource orchestrator 1412 may include a software design infrastructure (SDI) management entity for the data center 1400. The resource orchestrator 1412 may include hardware, software, or some combination thereof.

In at least one embodiment, as shown in FIG. 14, framework layer 1420 may include a job scheduler 1428, a configuration manager 1434, a resource manager 1436, and/or a distributed file system 1438. The framework layer 1420 may include a framework to support software 1432 of software layer 1430 and/or one or more application(s) 1442 of application layer 1440. The software 1432 or application(s) 1442 may respectively include web-based service software or applications, such as those provided by Amazon Web Services, Google Cloud and Microsoft Azure. The framework layer 1420 may be, but is not limited to, a type of free and open-source software web application framework such as Apache Spark™ (hereinafter “Spark”) that may utilize distributed file system 1438 for large-scale data processing (e.g., “big data”). In at least one embodiment, job scheduler 1428 may include a Spark driver to facilitate scheduling of workloads supported by various layers of data center 1400. The configuration manager 1434 may be capable of configuring different layers such as software layer 1430 and framework layer 1420 including Spark and distributed file system 1438 for supporting large-scale data processing. The resource manager 1436 may be capable of managing clustered or grouped computing resources mapped to or allocated for support of distributed file system 1438 and job scheduler 1428. In at least one embodiment, clustered or grouped computing resources may include grouped computing resource 1414 at data center infrastructure layer 1410. The resource manager 1436 may coordinate with resource orchestrator 1412 to manage these mapped or allocated computing resources.

In at least one embodiment, software 1432 included in software layer 1430 may include software used by at least portions of node C.R.s 1416(1)-1416(N), grouped computing resources 1414, and/or distributed file system 1438 of framework layer 1420. One or more types of software may include, but are not limited to, Internet web page search software, e-mail virus scan software, database software, and streaming video content software.

In at least one embodiment, application(s) 1442 included in application layer 1440 may include one or more types of applications used by at least portions of node C.R.s 1416(1)-1416(N), grouped computing resources 1414, and/or distributed file system 1438 of framework layer 1420. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1434, resource manager 1436, and resource orchestrator 1412 may implement any number and type of self-modifying actions based on any amount and type of data acquired in any technically feasible fashion. Self-modifying actions may relieve a data center operator of data center 1400 from making possibly bad configuration decisions and possibly avoiding underutilized and/or poor performing portions of a data center.

The data center 1400 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1400. In at least one embodiment, trained or deployed machine learning models corresponding to one or more neural networks may be used to infer or predict information using resources described above with respect to the data center 1400 by using weight parameters calculated through one or more training techniques, such as but not limited to those described herein.

In at least one embodiment, the data center 1400 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1300 of FIG. 13—e.g., each device may include similar components, features, and/or functionality of the computing device(s) 1300. In addition, where backend devices (e.g., servers, NAS, etc.) are implemented, the backend devices may be included as part of a data center 1400, an example of which is described in more detail herein with respect to FIG. 14.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1300 described herein with respect to FIG. 13. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. A method comprising:
determining, using one or more machine learning models and based at least on first image data representative of a first image associated with a first time, at least a first bounding shape associated with a head of a user and one or more first points associated with a body of the user;
determining, based at least on at least one of the first bounding shape and the one or more first points, at least a predicted bounding shape associated with the user;
determining, using the one or more machine learning models and based at last on second image data representative of a second image associated with a second time, at least a second bounding shape associated with the head of the user and one or more second points associated with the body of the user; and
determining, based at least on the predicted bounding shape, the second bounding shape, and the one or more second points, that the user depicted in the second image corresponds to the user depicted in the first image.

2. The method of claim 1, further comprising:
determining, using the one or more machine learning models and based at least on the first image data, a third bounding shape associated with a face of the user; and
determining, using the one or more machine learning models and based at least on the second image data, a fourth bounding shape associated with the face of the user,
wherein the determining the predicted bounding shape is further based at least on the third bounding shape, and wherein the determining the user depicted in the second image corresponds to the user depicted in the first image is further based at least on the fourth bounding shape.

3. The method of claim 1, wherein:
the predicted bounding shape is associated with the head of the user;
the method further comprises determining, based at least on the one or more first points, a second predicted bounding shape associated with the body of the user; and
the determining the user depicted in the second image corresponds to the user depicted in the first image comprises:
determining a first amount of overlap between the predicted bounding shape and the second bounding shape;
determining a second amount of overlap between the second predicted bounding shape and a third bounding shape that is determined based at least on the one or more second points; and
determining, based at least on the first amount of overlap and the second amount of overlap, that the user depicted in the second image corresponds to the user depicted in the first image.

4. The method of claim 1, wherein the determining the user depicted in the second image corresponds to the user depicted in the first image comprises:
determining a third bounding shape based at least on the second bounding shape and the one or more second points;
determining an amount of overlap between the predicted bounding shape and the third bounding shape; and
determining, based at least on the amount of overlap, that the user depicted in the second image corresponds to the user depicted in the first image.

5. The method of claim 1, further comprising:
determining, based at least on at least a portion of the one or more first points, a third bounding shape;
determining, based at least on the third bounding shape and the first bounding shape, that the first bounding shape is associated with the one or more first points; and
associating, based at least on the first bounding shape being associated with the one or more first points, the first bounding shape and the one or more first points with an identifier associated with the user.

6. The method of claim 1, further comprising:
determining, based at least on at least one of the second bounding shape or the one or more second points, a two-dimensional location associated with the user; and
determining, based at least on the two-dimensional location, a three-dimensional location associated with the user.

7. The method of claim 1, further comprising:
determining, based at least on the second bounding shape, a first two-dimensional location associated with the user;
determining, based at least on the one or more second points, a second two-dimensional location associated with the user;
determining, based at least on the first two-dimensional location, a first three-dimensional location associated with the user;
determining, based at least on the second two-dimensional location, a second three-dimensional location associated with the user; and
determining, based at least on the first three-dimensional location and the second three-dimensional location, a final three-dimensional location associated with the user.

8. The method of claim 1, further comprising:
determining, based at least on at least one of the second bounding shape or the one or more second points, a zone, from a plurality of zones, that the user is located within; and
outputting data based at least on the zone.

9. The method of claim 1, further comprising:
determining a first distance between the user and a centerline associated with a device and a second distance between a second user and the centerline associated with the device; and
determining, based at least on the first distance and the second distance, that the user is a primary user associated with the device.

10. The method of claim 9, further comprising determining, based at least on the user being the primary user and using at least one of the first image data or the second image data, one or more attributes associated with the user.

11. The method of claim 1, further comprising:
determining that the user is located in front of a device;
based at least on the user being located in front of the device, determining a first vector that is perpendicular to the device;
determining a second vector that is associated with an orientation of the user; and
determining, based at least on the first vector and the second vector, an attentiveness of the user with respect to the device.

12. The method of claim 1, further comprising:
determining that the user is located outside of an area in front of a device;
based at least on the user being located outside of the area in front of the device, determining a first vector that connects a side of the device to a head of the user;
determining a second vector associated with an orientation of the user; and
determining, based at least on the first vector and the second vector, an attentiveness of the user with respect to the device.

13. The method of claim 1, further comprising:
storing data representative of a track associated with the user; and
based at least on the determining the user depicted in the second image corresponds to the user depicted in the first image, updating the track associated with the user.

14. The method of claim 1, further comprising:
determining one or more criteria associated with the user, the one or more criteria including one or more of a distance to the user, a resolution associated with the user, or a velocity of associated with the user; and
determining, based at least on the one or more criteria, one or more attributes associated with the user.

15. A system comprising:
one or more processing units to:
determine, using one or more machine learning models and based at least on image data representative of an image, at least a first bounding shape associated with a head of a user and one or more points associated with a body of the user;
determine, based at least on at least a portion of the one or more points, a second bounding shape;
determine an amount of overlap between the second bounding shape and the first bounding shape; and
determine, based at least on the amount of overlap, to associate the first bounding shape and the one or more points with the user.

16. The system of claim 15, wherein the one or more processing units are further to:
determine, using the one or more machine learning models and based at least on the image data, a third bounding shape associated with a face of the user;
determine a second amount of overlap between the third bounding shape and at least one of the first bounding shape or the second bounding shape; and
determine, based at least on the second amount of overlap, to associate the third bounding shape with the user.

17. The system of claim 15, wherein the one or more processing units are further to:
determine, based at least on the first bounding shape and the one or more points, a third bounding shape associated with the user;
determine, based at least on the third bounding shape, a predicted bounding shape associated with the user;
determine, using the one or more machine learning models and based at least on second image data representative of a second image, at least a fourth bounding shape associated with the head of the user and one or more second points associated with the body of the user;
determine, based at least on the fourth bounding shape and the one or more second points, a fifth bounding shape associated with the user; and
determine, based at least on the predicted bounding shape and the fifth bounding shape, that the user depicted in the second image corresponds to the user depicted in the first image.

18. The system of claim 15, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system for performing conversational AI operations;
a system implementing one or more large language models (LLMs);
a system for hosting or presenting one or more digital avatars;
a system for generating synthetic data;
a system incorporating one or more virtual machines (VMs);
a system implemented at least partially in a data center; or
a system implemented at least partially using cloud computing resources.

19. A processor comprising:
one or more processing units to track a user from at least a first image represented by image data generated using one or more images sensors to a second image represented by the image data, wherein the user is tracked from the first image to the second image using at least two detections associated with the user in the first image and at least two detection associated with the user in the second image.

20. The processor of claim 19, wherein the processor is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system for performing conversational AI operations;
a system implementing one or more large language models (LLMs);
a system for hosting or presenting one or more digital avatars;
a system for generating synthetic data;
a system incorporating one or more virtual machines (VMs);
a system implemented at least partially in a data center; or
a system implemented at least partially using cloud computing resources.
